(19) United States
(12) Patent Application Publication
(10) Pub. No.: US 2014/0122601 A1
(43) Pub. Date: May 1, 2014

(54) API TRANSLATOR FOR PROVIDING A UNIFORM INTERFACE FOR USERS USING A VARIETY OF MEDIA PLAYERS

(71) Applicant: Milyoni, Inc., Pleasanton, CA (US)

(72) Inventors: Regan Poston, Menlo Park, CA (US); Barry T. Smith, San Jose, CA (US); Michael Darmousseh, Turlock, CA (US)

(73) Assignee: Milyoni, Inc., Pleasanton, CA (US)

(21) Appl. No.: 14/065,338

(22) Filed: Oct. 28, 2013

Related U.S. Application Data
(60) Provisional application No. 61/719,249, filed on Oct. 26, 2012.

(51) Int. Cl. H04L 29/06

(52) U.S. Cl. CPC H04L 29/06
USPC 709/204

(57) ABSTRACT

Embodiments are directed to systems and methods for delivering and displaying reconfigured media inputs with uniform and standardized user interfaces and functionality across different video players. One embodiment is directed to a method of interfacing with a plurality of video players comprising receiving a first media input associated with a first video player from a first content delivery network of a plurality of content delivery networks. The method further comprises receiving a reconfigured media input from a reconfigured media provider computer and loading the first video player on the user computer. A master platform may then generate a request for a time indicator, translate the request for the time indicator using first translation instructions associated with the first video player, send the translated request for the time indicator to the first video player, receive the time indicator, and perform one or more actions based on the received time indicator.

### CROSS-REFERENCES TO RELATED APPLICATIONS

This application is a non-provisional application of and claims priority to U.S. Patent Application No. 61/719,249, filed Oct. 26, 2012, the contents of which are incorporated by reference in its entirety for all purposes.

### FIELD

Embodiments of the invention relate generally to social media interactions and specifically to the user experience surrounding user viewing and user interaction with media inputs and non-media inputs using a system comprising reconfigured media providers, content delivery networks, social media websites, third party websites, and user computers.

### BACKGROUND

The rise of easy networking between computers and computing devices used by multiple people at disparate locations eventually led to the development of online social interaction, social networks and other activities that involve multiple people, typically at more than one physical location with interaction mediated via a network carrying data between clients, servers and nodes associated with various individuals and computers or computing devices.

Further, as easy networking has proliferated, many different entities have developed video players, streaming services, and other methods for sharing content over communication networks. Accordingly, entities or services may store media content and allow client computers to request and view content over the Internet using software installed on the client computer. In order to provide media content to a number of different users efficiently, content delivery networks (CDNs) have been implemented that may allow one or more entities to store and serve media content from their databases to users located throughout the world. For example, Brightcove®, YouTube®, Akamai®, and many other content providers have developed video players and infrastructure to allow such media content delivery.

In order to control the viewing experience of the media content and allow for entities to customize the media experience of the media content being delivered, content delivery networks have developed different video players configured to display their media content on a client computer (e.g., a YouTube® video player, a Brightcove® video player, a Akamai® video player). Accordingly, each content delivery network may encode media content to be displayed by a particular video player associated with the content delivery network or media provider.

However, the different video players comprise different viewing capabilities, controls, user interfaces, application programming interfaces (APIs), embedded metadata, and access rights. Accordingly, the viewing experience of a user, commands and controls for communicating with the video player or content delivery network, information included in the media content, and access rights available for media content are different depending on the video player in which the media content is configured to be displayed.

Accordingly, it is difficult and costly to interface with a number of different video players and provide uniform displays, functionality, and user interfaces across many different video players and content delivery networks.

### SUMMARY

Embodiments of the invention are directed to methods and systems for facilitating social interactions between users and providing a uniform interactive social experience for distributed viewers of a media input over a communications network. The media input may be provided by a content delivery network (“CDN”) to a user computer and may be configured to be displayed by a particular video player. Embodiments provide a standardized media player visual cover layer or master platform that translates the commands sent to and from video players using an application programing interface (API) of the video player. The master platform may use translation instructions to interact with a video player configured to display a received media input so that standardized, uniform functionality, user interface, and user experience may be provided. The master platform may provide different translation instructions depending on the media provider or content delivery network associated with the media input without requiring a different master platform to be designed for each specific video player.

Accordingly, embodiments of the present invention provide an API translator that determines encoded functions, interfaces, and commands of a media player based on a content delivery network or media provider associated with the media input. After determining the type of media player, embodiments of the present invention provide a translation instruction layer to a master platform that may be used to provide uniform functionality and a uniform user interface for any media input associated with any type of media player or media player functionality.

Embodiments of the invention provide the advantages of providing a standardized, uniform, predictable, and repeatable user interface, user functionality, and user experience for any type of media input provided by any content delivery network or media provider. Accordingly, a uniform experience may be provided independent of the type of information, interfaces, or functionality originally associated with a media input. As such, the user experience of viewing the media input within a reconfigured media experience is benefited because the user can depend on expected functionality and viewing experience for any media input, independent of the provider of the media content or the media player being used to display the content. Accordingly, the user does not have to learn different formats, locations, or symbols for different functionality on a media player and does not have to learn how to engage with a different type of media player. Furthermore, viewers can rely on the type of functionality they have become accustomed to and do not have differing levels of quality depending on the content delivery network.

Additionally, a reconfigured media provider may provide uniform functionality and user experiences that are intended when adding non-media inputs designed to allow a user to interact with a media input without having to provide a different specific master platform for each video player. Furthermore, the translation instructions may be used for any media inputs associated with a particular video player. Accordingly, embodiments provide efficient use of system resources by providing a uniform reconfigured media presentation experience without individually programming a master platform for each specific media input.

One embodiment of the present invention is directed to a method of interfacing with a plurality of video players comprising receiving a first media input from a first content delivery network of a plurality of content delivery networks. The media input may be associated with a first video player of the plurality of video players. The method further comprises receiving a reconfigured media input from a reconfigured media provider computer and loading the first video player on the user computer. A master platform may then generate a request for a time indicator and translate the request for the time indicator using first translation instructions associated with the first video player. The first translation instructions may be different than second translation instructions associated with a second video player. The method further comprises sending the translated request for the time indicator to the first video player, receiving the time indicator, and performing one or more actions based on the received time indicator.

Another embodiment is directed to a method of generating translation instructions for a first video player and a second video player comprising receiving a first media input and a first set of API commands associated with the first video player. The method further comprises determining a first mapping of the first set of API commands to a global set of master platform functions and generating the first translation instructions for a master platform corresponding to the first mapping. Further, the method comprises receiving a second media input comprising a second set of API commands associated with the second video player, determining a second mapping of API commands to the global set of master platform functions, and generating second translation instructions for the master platform corresponding to the second mapping. The first translation instructions and the second translation instructions may be configured to allow the master platform to interface with both the first video player and the second video player.

Another embodiment is directed to a method of providing translation instructions to a user computer by a server computer comprising receiving a request for a reconfigured media input from the user computer and determining a media input associated with the reconfigured media input. The server computer may further comprise determining the translation instructions associated with the media input and sending a response to the user computer including the translation instructions. The user computer displays the media input using a master platform that interacts with a video player associated with the media input using the translation instructions.

Other embodiments are directed to systems, portable consumer devices, and computer readable media associated with methods described herein.

A better understanding of the nature and advantages of embodiments of the present invention may be gained with reference to the following detailed description and the accompanying drawings.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers can indicate identical or functionally similar elements.

### BRIEF DESCRIPTION OF THE DRAWINGS

FIG. 1 shows a block diagram of an example of a reconfigured media presentation system for delivering both media inputs and non-media inputs to users, according to one embodiment of the invention.

FIG. 2 shows a block diagram of an example of a user computer, according to one embodiment of the present invention.

FIG. 3 shows a flow diagram of an example method of generating translation instructions for a video player, according to one embodiment of the present invention.

FIG. 4 shows an example of a format of a translated instruction database, according to embodiments of the present invention.

FIG. 5 shows a flow diagram of an example method of requesting and receiving reconfigured media inputs with translation instructions to provide a uniform user experience, according to embodiments of the present invention.

FIG. 6 shows a flow diagram of an example method of delivering a reconfigured media input to a user computer with translation instructions associated with a media input, according to one embodiment of the present invention.

FIG. 7 shows a flow diagram of an example method of using translation instructions to synchronize a playback time of video player with a master platform, according to embodiments of the present invention.

FIG. 8 shows a flow diagram of an example method of using translation instructions to synchronize a playback time and use the playback time to request chat messages associated with a media input, according to embodiments of the present invention.

FIG. 9 shows a flow diagram of an example method of using translation instructions to synchronize a playback time and use the playback time to display engagement information to a user computer and output data to third parties, according to one embodiment of the present invention.

FIG. 10 shows an example of a screenshot of a user display of a translated video player on a browser operating on a user computer, according to one embodiment of the present invention.

FIGS. 11A-11B show examples of two screenshots of a user display of a traditional video player on a browser operating on a user computer, according to one embodiment of the present invention.

FIG. 12 show a block diagram of an example of a user computer including a display of a translated video player on a browser for both of the media inputs shown in FIGS. 11A-11B, according to one embodiment of the present invention.

FIG. 13 shows an exemplary block diagram of a computer.

### DEFINITIONS

Prior to discussing embodiments of the invention, a further description of some terms can be provided for a better understanding of the invention.

A “user” may include any person or entity that interacts with a reconfigured media provider to view or interact with reconfigured media inputs. For example, a user may be a person that is registered to purchase, use, interact with, or view a movie through a reconfigured media presentation system. A user may also include a celebrity, moderator, persona, or other designated person that uses the social media presentment system to moderate, operate, direct, or otherwise has a special role outside of viewing or interacting with a media input.

A “reconfigured media provider” may include any entity that incorporates, includes, generates, adds, or otherwise provides non-media inputs associated with a media input for presentation to users. The reconfigured media provider may provide the media input and the non-media input directly to a user or may link or otherwise provide information to the user regarding where they can find the reconfigured media input.

A “media content provider” may include any entity that produces content. For example, a media content provider may include a band, artist, production company, record label, or any other entity that generates content for user consumption. Typically, a media content provider may provide a media input to a content delivery network or other entity to convert the media input into a format that is capable of being transmitted across the internet or other communications networks to requesting user computers.

A “content delivery network” may include any entity configured to deliver media inputs to user computers. Typically, media content providers generate media inputs and provide the media inputs to content delivery networks to actually send content to requesting user computers. Further, third parties may reference or otherwise provide a link to content provided by a content delivery network to user computers as a means for delivering content. For example, the reconfigured media provider may send a link to a media input that is stored on a content delivery network as part of the reconfigured media input that is delivered to a user computer. Further, content delivery networks may use various media players, content formats, and media files when delivering content to user computers.

A “media input” may include a film, song, TV episode, or any other digital media that is provided by a content provider prior to a user's viewing experience. The media inputs can be delivered for educational, entertainment, safety, or any other information sharing purposes. The media input may be a live broadcast (i.e., a live “stream”) or a pre-recorded media event. The media input may be stored at a content delivery network and may be associated with non-media inputs stored by the reconfigured media provider.

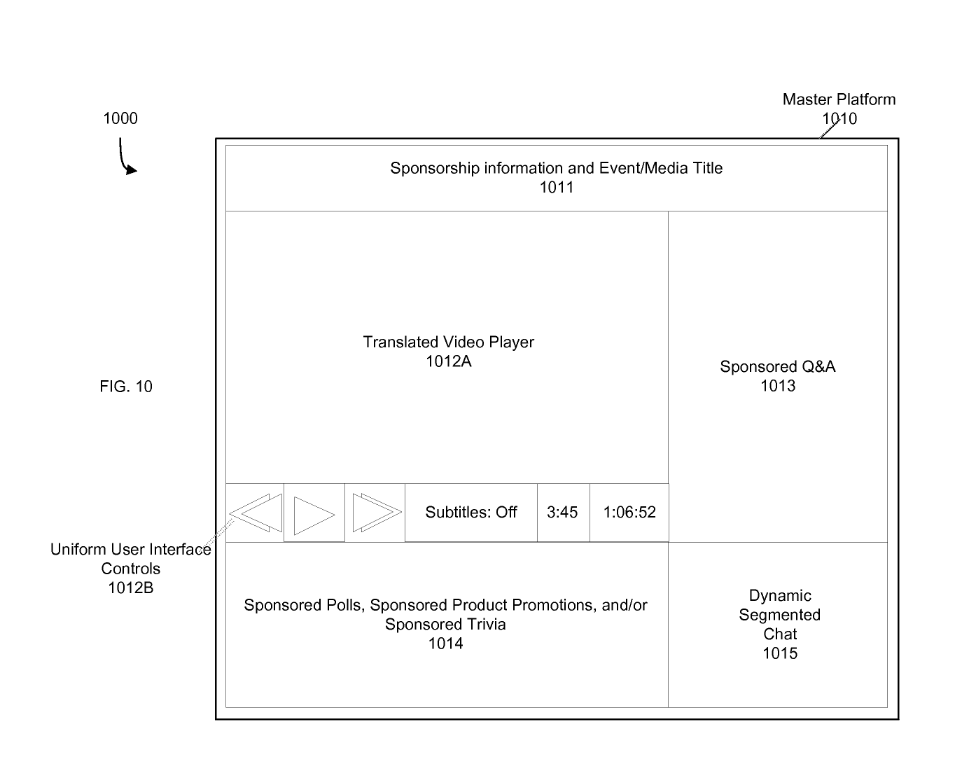

A “non-media input” may include inputs that are generated by viewers (i.e. users), those experiencing the media, by the system administrator (e.g., event producer, organizer, etc.), or by entities associated with a media input (e.g., advertisers, content providers, etc.) and are not part of the originally generated presentation (e.g., concert, movie, etc.). Non-media inputs could include the actions of a viewer to interact with another viewer or the system before, during, or after the viewing of a media presentation. For example, non-media inputs could include comments made during the viewing of a movie or TV episode that are either shared with another viewer of the presentation or saved at a particular time in the media for later viewing by other users. Non-media inputs could be displayed overlapping with the media input in the same area of the user interface displayed on browser or could be displayed in a separate section of the user interface. An exemplary user interface is provided in FIG. 10 and some examples of non-media inputs will be described in further detail below.

Additional non-media inputs and methods of requesting, receiving, delivering, using, and displaying non-media inputs may be found in U.S. patent application Ser. No. 13/961,783, filed Aug. 7, 2013, by Regan Poston, et al., U.S. Provisional Patent Application No. 61/872,153, filed Aug. 30, 2013, by Regan Poston, and U.S. Provisional Patent Application No. 61/874,900, filed Sep. 6, 2013, by Dean Alms, which are all hereby incorporated by reference in their entirety for all purposes.

An “interaction” includes any user actions that generate data that may be usable by a reconfigured media provider's platform or system. For example, interactions may include a user answering a trivia question by clicking an answer to a trivia question that is presented during playback of a reconfigured media input. Another example includes a user answering a poll question that is displayed during the playback of a movie through the social media presentation system or entering a chat message in the a segmented chat window during playback of a media input.

An “engagement” may include any non-media input that provides an opportunity for interaction by a user with the media presentation system. For example, engagements may include a quote, a like, a poll, trivia questions, and/or a video clip. The data for engagements (trivia questions, language in a quote, the video clip to be shared, etc.) may be pre-generated and included in a reconfigured media input delivered to a user computer. For example, engagements may be stored in the non-media input database at the reconfigured media provider and may include all engagement data for a media input or for multiple media inputs and may be associated to the relevant media input through a media input identifier. A media input identifier may relate to a specific reconfigured media input or a series of related reconfigured media inputs may share a media input identifier (e.g., a series of movie trailers for the same movie may share the same media input identifier).

A “reconfigured media input” may include any information that allows a user computer to display both a media input and the non-media input associated with the media input. Accordingly, the reconfigured media input may be a single file or communication including both the media input and the non-media input, may include the non-media inputs and links to the media input that may be provided by a content delivery network, may include only links to both the media input and the non-media input that are both provided by content delivery networks, or may include any combination thereof. Additionally, the reconfigured media input may comprise any other information that may be used to provide the functionality of the social media presentation system including allowing users to interact with non-media inputs during playback of a media input. For example, the reconfigured media input may include translation instructions associated with a media input or may provide an indicator for determining appropriate translation instructions.

A “media identifier” or “media input identifier” may include any information that allows an entity to identify a media input associated with a communication. For example, a media identifier may be a common identifier that is shared amongst all of the entities within the social media presentation system so that a media input, non-media inputs, or reconfigured media inputs may be identified by any of the entities within the social media presentation system.

A “video player” or “media player” may include any software module that is configured to display a media input to a user on a display of a computer. The media input may be encoded or configured to be played by a particular video player. The video player may be configured to display the media input in a particular manner, provide a particular user interface, and provide particular commands. The video player may be configured to interact with the computer system such that the video player may receive requests from the computer system, determine information associated with the media input (e.g., a playback time indicator, amount of playback time remaining, metadata encoded in the media input, and any other information that may be associated with the media input), and provide response information about the media input to the computer system. Further, in some embodiments, the video player may communicate with the content delivery network and passing requests and responses to and from the content delivery network to a computer system.

As used herein, “metadata” may include any information associated with a media input that is not a part of the original media content. The metadata may allow the video player to obtain additional information about the original media content. For example, metadata may include a movie title, actors, characters, captions, quotes, or any other information that is associated with the media input. The metadata may be time dependent such that the metadata provided by the video player may be associated with the current display or time of the media input. For example, a video player may be capable of reporting the current actors, characters, quotes, or captions associated with the current scene being displayed. The metadata may be provided with the media input, encoded into the media input, or may be provided outside of the media input.

As used herein, “API commands” may include any information that allows an outside module, component, or entity to interface with a software module, component, or entity within the social media presentation system. For example, API commands may include an application programming interface (API) provided by a video player that allows a computer system to request a time indicator, player status, or any other relevant information associated with the video player.

A “master platform” or “master player” may include a software module that is configured to display non-media inputs associated with the media input on a computer system. The master platform may be configured to communicate with a video player to receive time indicators, user input information, control information, and otherwise provide the social media presentation functionality using the non-media inputs. The master platform may use translation instructions received from a reconfigured media provider in order to communicate with any number of various video players with different functionality, controls, interfaces, etc. Further, the master platform may communicate with or cause the user computer to communicate with any entity within the reconfigured media presentation system. In some embodiments, the master platform may provide user interface controls for a video player and may receive user inputs, translate the user inputs into commands, translate the commands using translation instructions, and send the translated commands to a video player.

A “time indicator” may include any identifier for a playback time of a media input being displayed on a computer system. For example, a time indictor may include a time in seconds where the video player is currently displaying content.

As used herein, “synchronizing” may include any operation to match variables between two entities, modules, or components. For example, a playback time that is tracked by a master platform may be synchronized with a time indicator received from a video player. The playback time may be managed and monitored separately by the master platform but may be periodically updated with a time indicator received from the video player. Accordingly, if a user fast forwards, skips, pauses, stops, or otherwise changes the display of the media input by the video player, the master platform may determine that the playback time is not matching the previous playback and may determine that an event has occurred. Based on the readings of the time indicator received from the video player, the master platform may determine that the media is being fast forwarded (e.g., if the time indicator continues to be sent back ahead of where it should be), paused (e.g., if the time indicator remains the same for two consecutive readings), stopped (e.g., if no time indicator is provided), etc.

Alternatively, the time indicator may be received from the video player based on various criteria including types of user inputs or other information received from a video player. The criteria may include any information that may be relevant to the playback of the video player. For example, the criteria may be based on a type of user input or may be based on information received from the video player. A type of user input may include a user input to stop, play, pause, close, skip, or otherwise change the playback of the media input on the video player. For example, if the master platform either receives a published status from the video player (e.g., stopped, paused, skip, etc.) or receives the user input directly, the master platform may trip a flag or otherwise indicate that a criteria for refreshing the time indicator has been met. Accordingly, the master platform may request a time indicator from the video player as the criteria has been met.

As used herein, “translation instructions” may include any information that allows a master platform to communicate with a video player. For example, translation instructions may include a mapping of master platform commands or requests to the particular commands or requests that are understood by a particular video player and vice versa. The translation may occur through any suitable method. For example, the translation instructions may include a mapping of a command received from a master platform with a corresponding command for a video player. Alternatively, the transaction instructions may reformat, substitute, or alter information within a received command so that it is understood by the target module. For example, the translation instructions may convert a time indicator received from a video player in minutes (e.g., “1:05”) to seconds (e.g., “65”).

A “chat message” may include any information that is generated by a user, operator, provider, or any other entity of the reconfigured media presentation system that is shared with another user computer of the reconfigured media presentation system. The chat message may be associated with a reconfigured media input and may be received through any number of communications channels. For example, a chat message may include a text, graphic, picture, or other information that is entered by a user operating a user computer using a reconfigured media presentation system user interface, a social media network communication (e.g., a Tweet®, comment, post, or other information provided to a social media network), an email message or other message provided to fan page associated with a media input, an advertisement originating from a sponsor, content provider, or other entity of the reconfigured media presentation system related to a media input, or any other information that may be related to a reconfigured media input provided by the reconfigured media presentation system.

A “request” may include any message or series of messages sent from one module, entity, or other component within the reconfigured media presentation system that requests any information from another module, entity, or other component. For example, a request may include any message sent from a client computer to a server computer that requests any information from the server computer. For instance, a request for chat messages may include a request sent by a client computer to a reconfigured media provider server computer for chat messages to be displayed by the user computer. Alternatively, the request may include a request for information from one software module to another. For example, a request for a time indicator may be sent from a master platform loaded on a user computer to a video player loaded on a user computer for a playback time of a media input. The request may include any information that may allow the server computer to provide the information being requested. For example, a chat message request may include a user identifier and a media identifier to allow a reconfigured media provider to determine a reconfigured media input and a user account associated with the chat message request to determine which chat messages are relevant to the chat message request.

A “response” may include any message or series of messages sent from one module, entity, or any other component within the reconfigured media presentation system to another module, entity, or any other component that provides information requested in a request message. For example, a chat message response sent by a server computer in response to a chat message request may provide chat messages to be displayed by a user computer.

### DETAILED DESCRIPTION

Embodiments of the present invention are directed to methods and systems that facilitate social media viewing of media inputs delivered from content delivery networks and providing non-media inputs that allow users to interact with fellow viewers, advertisers, and friends.

Typically, media providers provide a recording of an event or a live broadcast feed to a content delivery network which reformats or stores the media input in a format that may be delivered or streamed to many users around the world through any suitable communication network (e.g., the Internet) and played on a user computer using a particular video player. The media inputs may be stored in any suitable form or file format (e.g., .mov files, .rm files, .wma files, .wmv files, .asf files, .flv files, .swf files, etc.) corresponding to particular video players (e.g., QuickTime Player, RealMedia Player, Microsoft Windows Media Player, Adobe Flash player, etc.). Therefore, a particular media input may be coded for a particular media player, thus requiring a user computer to install and maintain a number of media players to view different media inputs from different content delivery networks. The media inputs and/or video players may contain embedded instructions that relate to media player functions available to a user such that the user may interact with a media player to control the media input. Each content delivery network may provide different API instructions with the media inputs that allow interaction with each video player. These API instructions may have many different formats depending on the content delivery network, the media provider, and/or the video player.

For example, a media input delivered from a first content delivery network may comprise functionality including a play button, a pause button, time code information, a particular type of security interface, and functionality related to a secure handshake between the reconfigured media server and the media input. However, another content delivery network may provide the functionality of the first content delivery network but may also provide “cue points” or embedded information in the media input that informs a particular type of media player when to launch particular functionality (e.g., commentary). Furthermore, a third content delivery network may not provide time code or cue point functionality in their embedded API and instead may provide subtitles that other content delivery network API instructions do not provide.

However, a reconfigured media server may want to provide media inputs from each of the three content delivery networks and may want to provide standard user interfaces and experiences between each media input, even though each media input is coded for a different media player or different functionality. Accordingly, the reconfigured media server may determine the API instructions for each media input or video player and may provide translation instructions that translate the visual and functional interfaces and abilities of the media player to provide uniform functionality to a global set of functions (e.g., every media input may provide time code, cue points, and subtitles in the same area and same visual display for each content delivery network even though the media input does not provide these functions as delivered by the content delivery network). Accordingly, the reconfigured media server may determine the type of content delivery network that is associated with a particular media input and may include translation instructions with the media input information provided to the user in response to a request for a media input. When the browser operating on the user computer receives the media input from the content delivery network, a master platform using the translation instructions may interact with a video player displaying the media input to receive time indicators, user commands, metadata, and any other relevant information to the master platform for providing a social media presentation experience.

The social media presentation experience may be provided by a reconfigured media provider which may allow individual users or groups of users to watch a movie, TV show, live concert, or other media event at the same time from different devices in multiple locations. The service may allow users to engage with a media input through a number of social interactions, engagements, and capabilities. For example, a user may post comments and chat amongst segmented viewers and all viewers, ask celebrities questions, purchase products or services from advertisers or those products and services that are relevant to the event, participate in polls related to the media viewing experience, take quizzes relevant to the viewing experience, share content related to the media input, or otherwise interact with the online event. Further, the service can provide a virtual theater experience where groups of users can meet on a social media website using their electronic devices at numerous different locations and engage in a social activity centered on the media. Additionally, users may use the service individually to have an interactive experience with any media input to create a community with people of similar interests from around the world.

The different media inputs may be delivered by different content delivery networks. However, not every content delivery network may provide a media input that may be accessed or played by the same video player. Accordingly, typically a content delivery network may format all of the media inputs they deliver to be compatible with a particular type of media player. Alternatively, some content delivery networks may allow media providers to determine the functionality of the media input for their predetermined media player or may limit certain types of media inputs to only have certain functionality provided to a browser being operated on a user computer.

Many of the media inputs may have their own embedded media player functions or many different media inputs may have idiosyncrasies within each type of media player commands, interfaces, and functionality. Accordingly, the user experience may be altered depending on the type of content delivery network providing the media input or the media provider that originally captured, produced, or delivered the media input to the content delivery network. Further, the various video players may have different interfaces allowing information to be shared between video players.

Accordingly, in order for a reconfigured media provider to provide the social media presentation experience associated with the reconfigured media provider, a master platform may have to interface with multiple different types of video players with different interfaces, functionality, and capabilities. For example, a master platform may use a time of a media input to perform a number of actions. However, the interfaces for obtaining time between various players may vary widely and thus, a master platform may be unable to understand, sync, and follow the playback time of where the user is viewing the data across a number of different video players. Therefore, the master platform may request time from the various players using translation instructions that translate the time indicator request to match the specific interfaces, APIs, and commands that each video player may understand and respond to.

For example, a first video player may report a time indicator as a “playtime” and report the value in minutes. Alternatively, a second video player may not report the time unless requested and may call the time a “current value” and report the time in seconds. Accordingly, a single master platform may not understand the various times reported by the different video players and the video players may not understand requests sent by the master platform. Therefore, requests and responses between various players may be translated in order for a master platform to request, receive, understand, and use the time indicator values. The translation instructions may be configured to translate requests, responses, and received information related to any possible data that a video player may provide to the master platform. For instance, the translation instructions may be used to translate information associated with interface controls (e.g., the user pressing play on the video), metadata associated with the media input (e.g., characters, actors, language translations, etc.), duration of playback (e.g., time left in the media input), or any other potentially useful information.

The global functions that may be provided by the master platform using the translation instructions may relate to any interaction with a media input. For example, the set of global functions may be as simple as a play and pause functionality, or as complex as media interactions with comments, product purchases, or other non-media related inputs that the consumer enters while interacting experiencing the media input. For example, the global set of media player functions may include a particular placement, position, font, etc. of subtitles, buttons for controlling or interacting with the media input (e.g., play, pause, fast forward, etc.), the interacting with “social widgets” or other non-media inputs related to the media input (e.g., quizzes, polls, likes, image pinning, etc.), video bit rates, metadata that is used to trigger sharable clips, likes, quotes, etc. The global media player functions may also include security functions, time codes, handshakes between entities, cue points, subtitles, three dimensional controls, etc. Any interaction, visualization, and/or features that may be used to interact or view the media input may be implemented using the translation instructions. Accordingly, a uniform visual and functional experience may be provided through the use of the translation instructions by the browser operating on the user computer.

### I. Reconfigured Media Presentation System

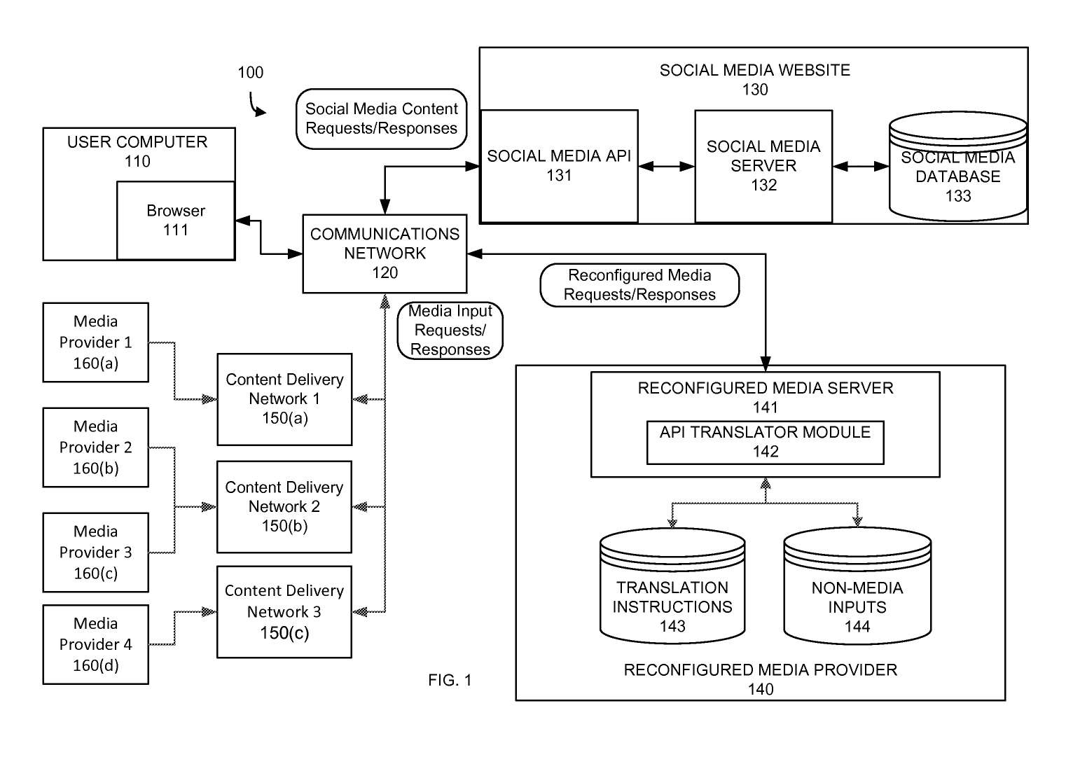

FIG. 1 shows a reconfigured media presentation system 100 for delivering media inputs and non-media inputs to users. The reconfigured media presentation system 100 comprises a user computer 110, a reconfigured media provider 140, a social media website 130, a number of content delivery networks 150(a)-150(c), and a number of media providers 160(a)-160(d). Although the present system is shown in the context of a social media website 130, the social media aspects could be provided by another entity in the system or any other third party server computer 170. All of the above entities may be coupled to a communications network 120 that allows each of the entities to send and receive communications to and from other entities.

The reconfigured media presentation system 100 may allow user computers 110 to request and receive reconfigured media inputs that may facilitate the viewing of media inputs (e.g., movies, videos of plays, concerts, recordings of music, etc.) along with non-media inputs (e.g., chat messages, poll questions, trivia, questions and answers, etc.) related to the media input.

For example, one media content provider 160(a) of a number of different content providers 160(a)-160(d) may provide a media input to one content delivery network 150(a) of a number of different content delivery networks 150(a)-150(d) for distribution to user computers 110 through a communications network 120. The content delivery network 150(a) may reconfigure and store the media input for future delivery. The media input may either be an encoded file of a prior performance, recorded video, recorded event, or a live video feed of a performance or event that may be encoded by the content delivery network 150(a). The content delivery network 150(a) may use a media application to reconfigure the media input to a format that can be streamed from the content delivery network 150(a) to user computers 110 that request the media input via a social media website 130, reconfigured media provider 140, or directly from the content delivery network 150(a). In some embodiments, the functionality provided by the content delivery network 150(a) may also be accomplished by the reconfigured media provider 140 which may host the media inputs directly or may reconfigure the media inputs for distribution and provide them to other content delivery networks 150(b)-150(c).

The media content provider 160(a) may also provide the media input to a reconfigured media provider 140 that may generate and/or configure non-media inputs associated with the media input in a reconfigured media input. The reconfigured media input may include non-media inputs that allow users of a social media website 130, the reconfigured media provider 140, or any other third party website (not shown) to interact with the media input through the use of sharable clips, quotes, songs, and annotated chat. The non-media input options can be added using the social media website's application programming interface (API) 131 or APIs associated with a reconfigured media server 141. The reconfigured media input may include the link to the media input hosted at the content delivery network 150(a) such that when a reconfigured media input is sent to a user computer 110, the user computer 110 may contact the content delivery network 150(a) for the media input associated with the non-media inputs. The non-media inputs, APIs for each media input, and the links to the appropriate media inputs at various content delivery networks 150(a)-150(c) may be stored in a reconfigured media inputs database (not shown) at the reconfigured media provider 140. In some embodiments, the reconfigured media provider 140 could also provide the reconfigured media from another party (not shown) or the media content provider 160 could reconfigure the media content prior to providing it to the reconfigured media provider 140.

After generating a reconfigured media input, the reconfigured media server 141 may receive a reconfigured media input request from a user computer 110 to view the media input. Alternatively, the reconfigured media server 141 could receive a reconfigured media request from the social media website 130 to stream the media input to a particular user computer 110. The reconfigured media input may be provided through a communications network 120 to a browser 111 operating on a user computer 110. The social media API 131 may allow users to interact with each other using the application programming interface (API) of each social media website 130. Therefore, a different reconfigured media input can be created for different social media websites 130 with different APIs embedded.

The social media API 131 also allows the reconfigured media server 141 access to the user's profile information on the social media database 133 of the social media website 130. The reconfigured media server 141 can also require the user to log in order to determine the user's profile information that is stored by the reconfigured media provider 140 at a user information database. Each user account may be identified by a unique user identifier.

The reconfigured media server 141 can create a secure connection or “handshake” with the social media website 130, the content delivery network 150(a), or the browser 111 operating on the user computer 110, and deliver the reconfigured media input to the user computer 110. Accordingly, a user may now interact with the reconfigured media input including both the media input and non-media inputs associated with the media input.

The content delivery network 150(a)-150(c) may use a media application (not shown) to reconfigure the media input to a format that can be streamed from the content delivery network 150(a)-150(c) to user computers 110 that request the media input via a reconfigured media request/response. The reconfigured media request/response is generated by a user controlling a browser 111 operating on a user computer 110 requesting a media input through a social media website 130 or other third party website. The user computer 110 may also request the information directly from the reconfigured media server 141. The reconfigured media provider server computer 141 may provide an application module or master platform module 113 that may be programmed using a social media API 131 and/or reconfigured media API (not shown) generated and sent from the reconfigured media server 141 in response to a request for a reconfigured media.

The reconfigured media provider 140 may previously have received a media input or API instructions corresponding to a media input from a content delivery network 150(a)-150(c) prior to receiving a reconfigured media request corresponding to a media input. Accordingly, the reconfigured media provider 140 may determine what API instructions are provided by a content delivery network 150(a)-150(c) or media provider 160(a)-160(d) prior to receiving a request corresponding to a media input. As explained previously, so that the user experience may be uniform and standardized across content delivery networks 150(a)-150(c) and media inputs, the reconfigured media provider 140 may translate the API instructions provided for a particular type of media input or content delivery network 150(a)-150(c) using an API translator module 142. Accordingly, the reconfigured media provider 140 may determine the functionality included in a media input provided by a particular content delivery network 150(a)-150(c) and may generate translated API instructions for each content delivery network 150(a)-150(c), media provider 160(a)-160(d), or media input. The translated API instructions may be generated by translating API instructions into a set of translation instructions by mapping API commands associated with a master platform to match the API commands of a video player. The reconfigured media server 141 may store the translation instructions in a translation instructions database 143.

The reconfigured media provider server 141 may also allow third party websites (not shown) to use API or software development kit (SDK) commands to request particular functionality from the reconfigured media provider 140 associated with a particular media input. Accordingly, non-media inputs may be delivered to a user computer 110 associated with the third party website (not shown). Accordingly, a third party website (e.g., a merchant website) may use aspects of the social media presentation system 100 to provide additional functionality related to non-media inputs that are not provided by content delivery networks 150(a)-150(c). Accordingly, the merchant may include a video showing off a product and may embed the reconfigured media providers' functionality using API or SDK code in the video linked to their website. The video may be hosted by a content delivery network 150(a)-150(c) and the video may embed portions of the social media presentation experience provided by the reconfigured media provider 140. For example, the merchant may embed functionality allowing a user to see particular non-media inputs during playback of the video. For example, the merchant could add engagements, such as poll questions or trivia questions, to the video that allows a user to interact and engage with the video content. Further, the merchant could embed API commands to allow for chat functionality, question and answer information, connections to social media websites or profiles, etc.

Additional information and capabilities of the reconfigured media presentation system (also referred to as a social media presentation system) may be found in U.S. patent application Ser. No. 13/961,783, filed Aug. 7, 2013, by Regan Poston, et al., U.S. Provisional Patent Application No. 61/872,153, filed Aug. 30, 2013, by Regan Poston, and U.S. Provisional Patent Application No. 61/874,900, filed Sep. 6, 2013, by Dean Alms, which are all hereby incorporated by reference in their entirety for all purposes.

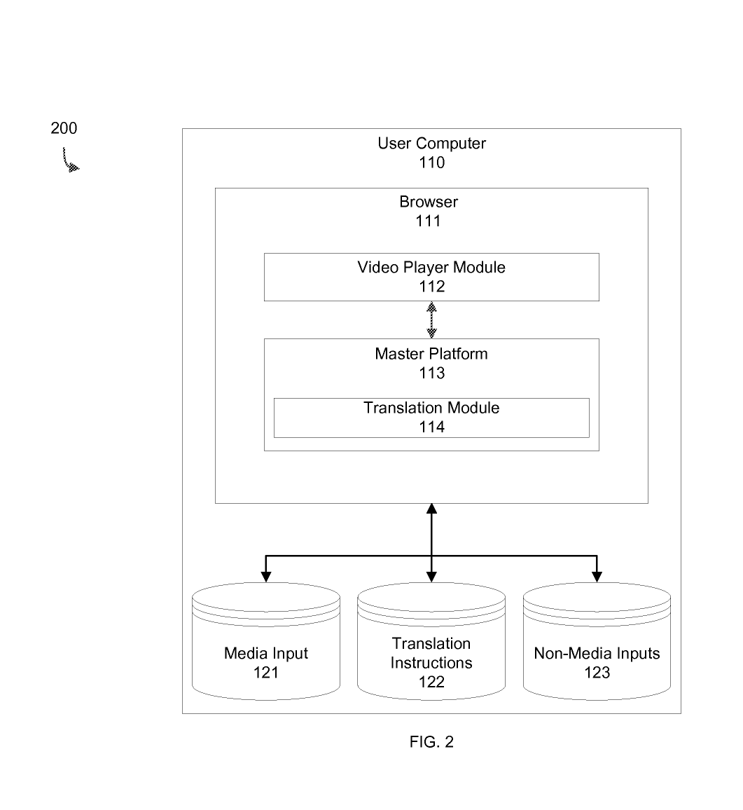

FIG. 2 shows a block diagram 200 of an example of a user computer 110, according to one embodiment of the present invention. The user computer 110 may comprise a browser 111 that may be configured to load a video player module 112 and a master platform module 113. The browser 111 may be communicatively coupled with one or more storage mediums 121-123 comprising a media input 121, translation instructions 122, and non-media inputs 123 (e.g., engagements and/or chat messages associated with the media input) that may be stored on the user computer 110. The storage mediums 121-123 may include a cached temporary memory or may be permanent storage mediums of the user computer 110. Accordingly, the information may be received from the reconfigured media provider 140 and content delivery network 150(a)-150(c) just before or during playback of the media input or may be received and stored far ahead of displaying the media input and non-media inputs.

The browser module 111 may include any software module that is configured to allow a user to receive and display information received and sent over a communication network 120. The browser module 111 may include any code or functionality to allow the browser 111 to load a variety of video player modules 112 that may be stored on a memory of the user computer 110. Additionally, the browser 111 may include any code or functionality to allow the browser 111 to load a master platform module 113 that may be stored on a memory of the user computer 110.

The video player module 112 may include a software module that is configured to display media inputs or media content. The media input may be encoded to be played by a particular video player 112 that is configured to provide specific functionality and display information associated with the media input. Accordingly, the user computer 110 may have multiple different video player modules 112 configured to play a number of different media inputs associated with different content delivery networks 150(a)-150(c) or media providers 160(a)-160(d). Further, the video player module 112 may have specific interfaces for communicating with other modules, components, and entities within the social media presentation system.

The master platform module 113 may include a software module configured to provide non-media inputs associated with the media input being displayed by the video player module 112. The master platform 113 may provide additional social media functionality that is not provided by the video player 112. For example, the master platform module 113 may comprise code or other functionality that may display engagements and chat messages associated with a media input. Further, the master platform 113 may comprise code to allow the master platform 113 to interact with the video player module 112. For example, the master platform 113 may request time indicators, a video status, video control, and any other information from the video player 112. Further, the master platform 113 may be capable of reporting or providing information to the video player module 112.

The master platform module 113 may be provided by the reconfigured media server 141 in a reconfigured media input. The reconfigured media input may include operational code for the master platform 113 to format, provide social media presentation system functionality, and to configure the user interfaces described herein. For example, the master platform module 113 may format a browser window and/or a video player 112 loaded on a browser 111, may interact and communicate with the video player 112, and may display additional non-media inputs associated with a media input to provide a uniform and social user experience.

Further, the master platform 113 may be capable of using a translation module 114 to translate requests, commands, and any other information received from the video player 112 into a form that the master platform module 113 may understand. Alternatively, the master platform module 113 may use the translation module 114 to translate commands, responses, or any other information sent to the video player 112 so that the video player 112 may understand the information.

The translation module 114 may include a software module configured to translate communications and information between the video player module 112 and the master platform module 113. Accordingly, the translation module 114 may be capable of determining translation instructions 122 associated with the video player module 112 and may use the appropriate translation instructions 122 to translate the communications. Any suitable method may be used to determine the appropriate translation instructions 122. For example, the translation instructions 122 may be determined by being the only translation instructions 122 stored on the user computer 110, by receiving a translation instructions identifier, or by receiving a location of where to find the translation instructions 122.

The translation instructions 122 may be stored on one or more computer-readable storage mediums and may be accessible to the master platform 113 and/or any other processor, component, or software module on the user computer 110. The master platform 113 may store the translation instructions 122 received from the reconfigured media server computer 141 or the translation instructions 122 may previously be stored on the user computer 110 as part of a previous installation of the various modules.

Embodiments of the present invention may be directed at multiple different aspects of the reconfigured media presentation system 100 that may be implemented to provide the functionality described herein. For example, embodiments may be directed at generating translation instructions 122, providing the translation instructions 122, and using the translation instructions 122 to display both media and non-media inputs on the user computer 110. Each of these aspects of the reconfigured media presentation system are addressed separately in further detail below.

### II. Generating API Translation Instructions

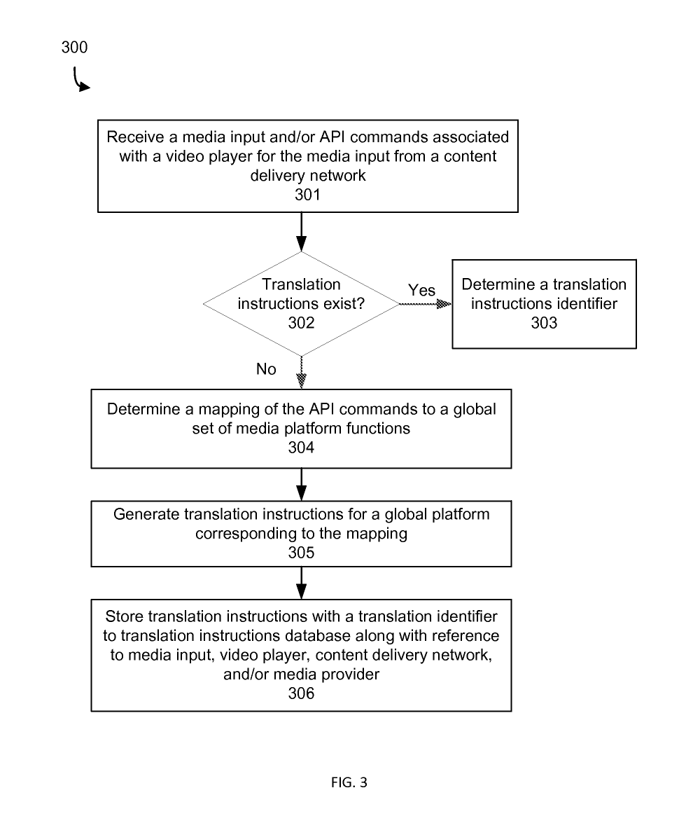

FIG. 3 shows a flow diagram of an example method 300 of generating translation instructions for a video player 112. The method 300 may be performed by a reconfigured media provider 140 when receiving new media inputs from a media provider 160 or content delivery network 150. Accordingly, the method may be performed during registration of a new media input with the reconfigured media provider 140 to provide non-media inputs (e.g., social media chat messages) associated with the media input.

At step 301, a reconfigured media provider 140 receives a media input or instructions associated with a media input from a content delivery network 150. The reconfigured media provider 140 may receive the media input or the API instructions for a media input from the content delivery network 150 in response to a request for the information from the reconfigured media provider 140, in response to a contract formation between a media provider 160 and the reconfigured media provider 140, or at any suitable time or place. The API instructions or commands may be associated with a particular video player 112. The API commands may be encoded in the media input or may be provided as part of the video player 112 that may be installed on a user computer 110. The API commands may be different for two different media inputs received from the same content delivery network 150 or may be different. Accordingly, the API commands may be dependent on the content delivery network 150, video player 112, media provider 160, or on any other variable associated with the media input.

At step 302, the reconfigured media provider 140 may determine whether translation instructions exists for the media input, media provider 160, or content delivery network 150. If the content delivery network 150 includes the same API instructions with every media input, it may be sufficient to merely determine that the reconfigured media provider 140 has translated a media input for that content delivery network 150 in the past. However, if a content delivery network 150 provides different API instructions or features for each of the media inputs, depending on, for example, the choice of the media provider 160, then the reconfigured media provider 140 may determine that even though translation instructions exists for that content delivery network 150, translation instructions does not exist for that media provider 160 and content delivery network 150.

The translation instructions database 143 may have a flag or field that informs the reconfigured media provider 140 if translation instructions will be sufficient to translate all media inputs for a particular content delivery network 150 or if separate translation instructions may be necessary for each media provider 160 or even each media input. This determination may be made in any suitable manner as one of ordinary skill in the art would recognize. For example, the content delivery network 150 may include an API command type field or API command identifier with the media input that informs the reconfigured media provider 140 of what type of media player functions are allowed with that media input, or the reconfigured media provider 140 may assign such an identifier internally when processing media inputs, or any other suitable method of determination may be used.

At step 303, if the API translator module 142 determines that translation instructions already exist for the media provider 160, content delivery network 150, or video player 112 associated with the media input, the API translator module 142 may determine a translation instructions identifier associated with the translation instructions. The API translator module 142 may then store the translation instructions identifier with the non-media inputs associated with the media input such that future requests related to that media input may easily determine the translation instructions that should be used.

At step 304, if no translation instructions exist for the received media input, the reconfigured media provider 140 may start a process of translating the API commands or instructions into translation instructions by determining a mapping of the API commands to global master platform functions.

The global set of master platform functions may include any potential functionality that a reconfigured media provider 140 may want to provide. For example, the global set of master platform functions, controls, or commands may include requesting a time indicator or additional data associated with metadata from a loaded video player 112, interpreting time indicators and additional information provided by a loaded video player 112, providing commands associated with user inputs to a loaded video player 112, or any other potential functionality that a master platform 113 may use to provide reconfigured media presentations to a user computer 110.

Accordingly, the API translator 142 may analyze the API commands of the master platform 113 and the API commands of the video player 112 to determine how the functionality is related. The functionality may be different in naming conventions (e.g., playback time vs., information formats (e.g., time referenced in minutes vs. seconds), command format (e.g., placement and order of information included in a command), information included in a particular command (e.g., one player may desire to have the previous time indicator included in a request for a new time indicator while others only require a request for a new time), information that is available (e.g., different players may comprise different metadata or information that may be returned), or through any other ways. For example, if the mapping determines that a master platform 113 references time as a “playback time” and a particular video player 112 references time as a “current time,” the API translator module 142 may determine the mapping between the naming conventions in the API controls.

Accordingly, the API translator module 142 may be capable of analyzing API commands, comparing the API commands, and determining the differences between the API commands to determine the mapping between commands. The mapping may include the differences between the commands that are determined by the API translator module 142.

At step 305, the API translator module 142 generates the translation instructions corresponding to the content delivery network, media provider 160, or media input by generating translation instructions corresponding to the mapping. For example, if the mapping determines that a master platform 113 references time as a “playback time” and a particular video player 112 references time as a “current time,” the API translator 142 may generate the translation instructions by including a command to substitute “playback time” to “current time” for any communications between the video player 112 and the master platform 113. Accordingly, the translation instructions may include instructions that allow a media player to alter the format, naming conventions, size, length, and information contained within API commands of the master platform 113.

The translation of the API commands may occur manually (e.g., by having engineers code particular functionality that matches the desired functions) or may be automatic by the API translator 142 to identify corresponding commands using data algorithms to analyze the source code, different coding languages, or other information and determine a mapping. Further, the translation may be automatic if recognized API functionality is included in the API commands such that an API translator module 142 may recognize the API functionality and may know how to translate the preexisting or pre-coded API functions into the desired media player functions.

Furthermore, the translation instructions may be implemented by a master platform 113 in any suitable manner. For example, the translation instructions may translate API commands and other instructions at the reconfigured media provider 140 and include the translated API commands in the translation instructions such that the translation instructions already comprise the translated API commands. Alternatively, the translation instructions may include the operations that may be performed by the master platform 113 installed on the user computer 110 to translate the API commands each time a message is sent.

At step 306, the translation instructions are stored in a translation instructions database 143 with a translation identifier and a reference to the associated media input, content delivery network 150, and/or media provider 160. In this manner, the API translator module 142 may determine the associated translation instructions based on a request for a media input, based on the media provider 160 associated with the media input, or based on the content delivery network 150 associated with a media input/media provider 160. As such, the translation instructions may be stored, recalled, and applied in any suitable manner based on the stored information. Accordingly, the translation instructions may be applied to media inputs with similar API instructions or commands in the future without having to generate a new translation instructions for each media input.

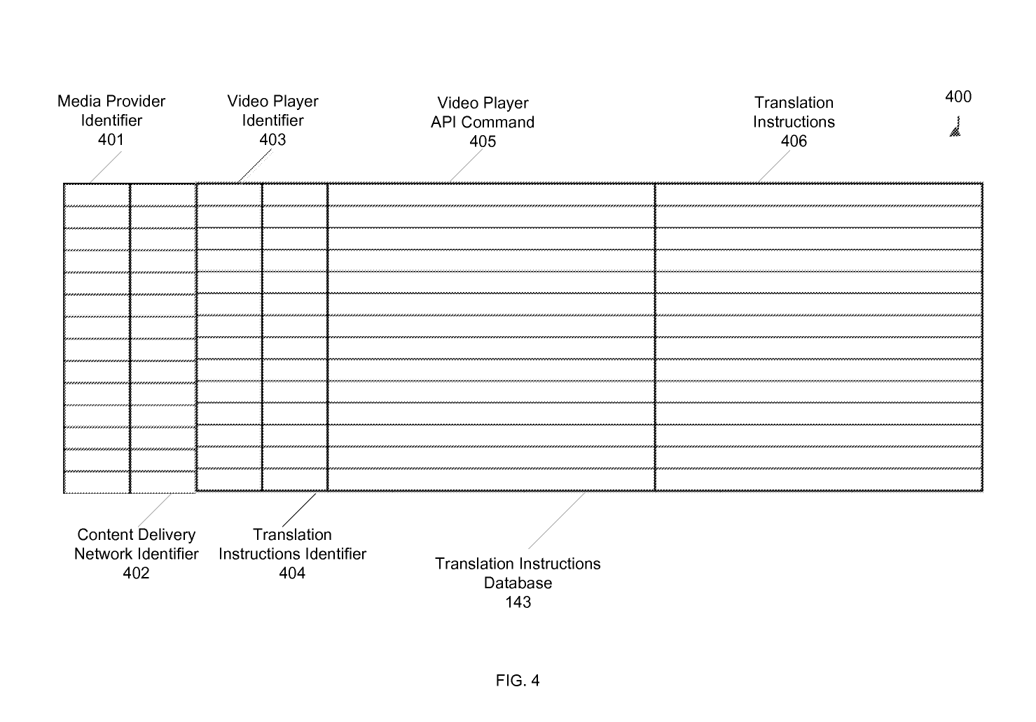

FIG. 4 shows an example of a format 400 for translation instructions stored in a translation instructions database 143, according to embodiments of the present invention. As can be seen in FIG. 4, depending on whether a content delivery network 150(a)-150(c) includes the same API instructions for each type of media input, provided by each particular media provider 160(a)-160(d), or whether each media input may include different API instructions, the translation instruction database 143 may comprise a different set of translation instructions for each media input or may merely have a different set of translation instructions for each content delivery network 150(a)-150(c) or media provider 160(a)-160(d).

The translation instructions for a particular media input may comprise any suitable information needed to determine the correct translation instructions for a particular media input and/or video player 112. For example, the translation instructions may include a media provider identifier 401, a content delivery network identifier 402, a video player identifier 403, a translation instructions identifier 404, a video player API command 405 associated with the video player 112, and the translation instructions 406 for providing the universal functionality. The identifiers may include any suitable information to identify the corresponding entity. For example, the identifiers could be an alphanumeric sequence of characters that are assigned to an entity during registration. Any other words, names, or characters could be used as identifiers.

After translation instructions has been generated for a media input, the reconfigured media provider 140 may include the translated API instructions in responses to media input requests from user computers 110 such that a global set of master platform functions may be provided for each and every media input delivered by the reconfigured media provider 140. This process may be repeated for a second media input associated with a second video player (not shown) and the translation instructions may be configured to allow the master platform 113 to interface, communicate, and/or control both the first video player 112 and the second video player.

Method 300 and any of the methods described herein may be totally or partially performed with a computer system including one or more processors, which can be configured to perform the steps. Thus, embodiments are directed to computer systems configured to perform the steps of any of the methods described herein, potentially with different components performing a respective step or a respective group of steps. Although presented as numbered steps, steps of methods herein can be performed at a same time or in a different order. Additionally, portions of these steps may be used with portions of other steps from other methods. Also, all or portions of a step may be optional. Any of the steps of any of the methods can be performed with modules, circuits, or other means for performing these steps.

### III. Providing API Translation Instructions to a User Computer

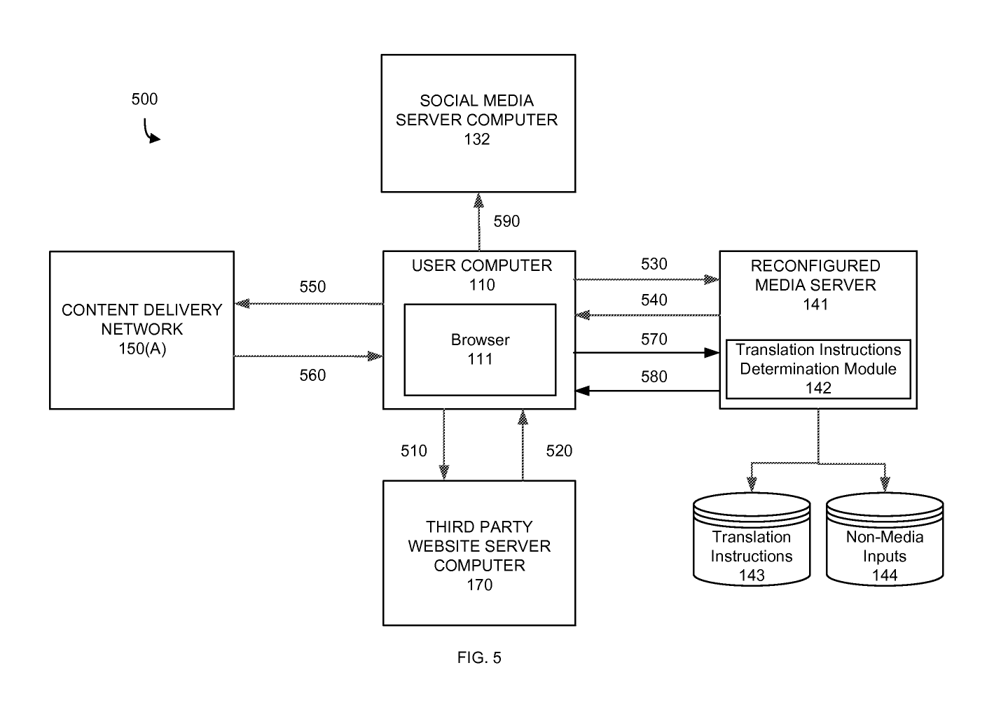

FIG. 5 shows a flow diagram of an example method 500 of requesting and receiving reconfigured media inputs and translation instructions associated with the media inputs to provide a uniform social media presentation experience, according to embodiments of the present invention. The system shown in FIG. 5 includes a third party website server computer 170 that may host information related to the reconfigured media presentation system and may facilitate the delivery of the reconfigured media input to the user computer 110. For example, the third party website 170 could include a merchant website that wishes to provide media inputs with the social media functionality provided by the reconfigured media provider 140.

First, at step 510, a user computer 110 may select a media input to view while visiting a third party website 170. The third party website 170 may include a merchant, social media website 130, employer website, health provider, or any other entity that wishes to provide media content over a communications network 120. The user may use a browser 111 operating on the user computer 110 to receive and display information received from a third party website server computer 170 and the user may provide a user input to the user computer 110 to select the media content for viewing.

At step 520, the third party website server computer 170 may respond to the user's selection by sending a third party reconfigured media input response message to the user computer 110. The third party reconfigured media input response message may comprise directions for the browser 111 operating on the user computer 110 to request a reconfigured media input from a reconfigured media server 141 operated by a reconfigured media provider 140.

At step 530, a user computer 110 generates a request for a reconfigured media input and sends the reconfigured media input request to the reconfigured media provider 140. The reconfigured media provider 140 receives the reconfigured media input request message from a user computer 110 and determines the appropriate non-media inputs associated with the reconfigured media input request message.

Accordingly, the browser 111 operating on the user computer 110 sends a reconfigured media request to the reconfigured media server 141 that indicates the media input that the user is attempting to view. The reconfigured media provider 140 may ask the user to log-in to their profile or may obtain user information from the social media website 130, or through any other suitable manner to determine that the user is allowed to view the media input.

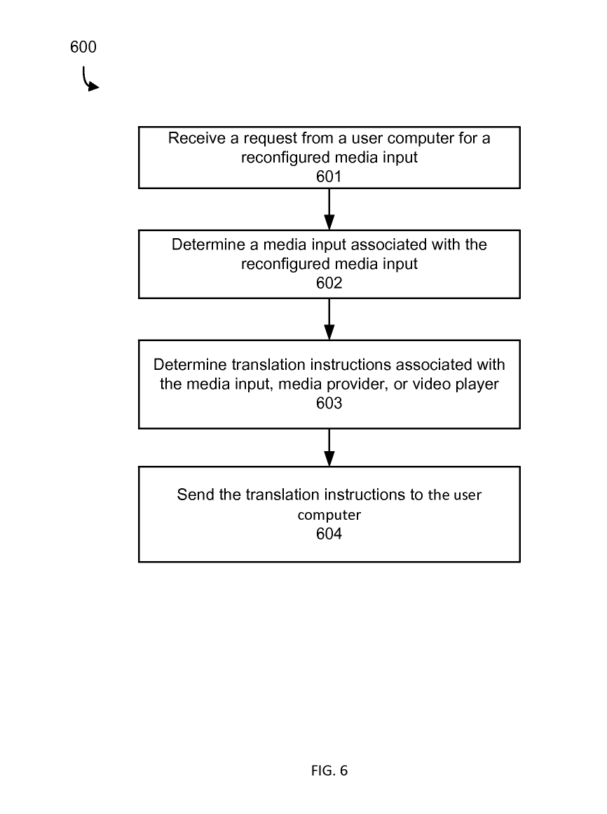

At step 540, the reconfigured media provider 140 may generate a reconfigured media input response message including non-media inputs associated with the media input and send the reconfigured media input response message to the user computer 110. In order to generate the correct reconfigured media response message, the translation instructions determination module 142 of the reconfigured media server 141 may determine a media input associated with the requested reconfigured media input and translation instructions associated with the media input. The reconfigured media provider 140 may determine the media input through any suitable manner. For example, the request for the reconfigured media provider 140 may include an identifier for the media input, a link location for the media input, a third party indicator for the media input, or any other suitable information to allow the reconfigured media provider 140 to identify the appropriate media input. A method for determining the translation instructions associated with a reconfigured media input request is provided in more detail below in reference to FIG. 6.

After determining the translation API corresponding to the media input, the translation instructions determination module 142 may include the translation instructions in the reconfigured media response that is sent to the user computer 110. The browser 111 operating on the user computer 110 may then have the translation instructions stored on the user computer 110 when the media input is received from the content delivery network 150(a). Alternatively, the translation instructions determination module 142 may indicate a storage location or a translation instructions identifier for the master platform 113 to load the appropriate translation instructions that are already stored on the user computer 110. Either way, the translation instructions may be used by the master platform 113 operating on the user computer 110 to translate API commands between the video player 112 and the master platform 113 on the user computer 110.

At step 550, the browser 111 operating on the user computer 110 sends a request for the media input to the content delivery network 150(a). After receiving the response from the reconfigured media server 141, the browser 111 operating on the user computer 110 sends a request to the content delivery network 150(a) for the media input. The response from the reconfigured media server 141 may comprise the address for the media input hosted at the content delivery network 150(a) so that the browser 111 operating on the user computer 110 knows where to request the media input from. The reconfigured media server 141 may also send the request to the content delivery network 150(a) to deliver the media input to the user computer 110 or any other suitable method of requesting the media input may be implemented including the reconfigured media provider 140 actually delivering the media input to the user computer 110 if they are hosting the media input.

At step 560, the content delivery network 150(a) may generate a media input response and may send the media input to the user computer 110. The browser 111 operating on the user computer 110 may receive the media input from the content delivery network 150(a). At this point, the browser 111 comprises all the information necessary to provide a global set of functions to interact with the media input when the user computer 110 receives the media input from the content delivery network 150(a).

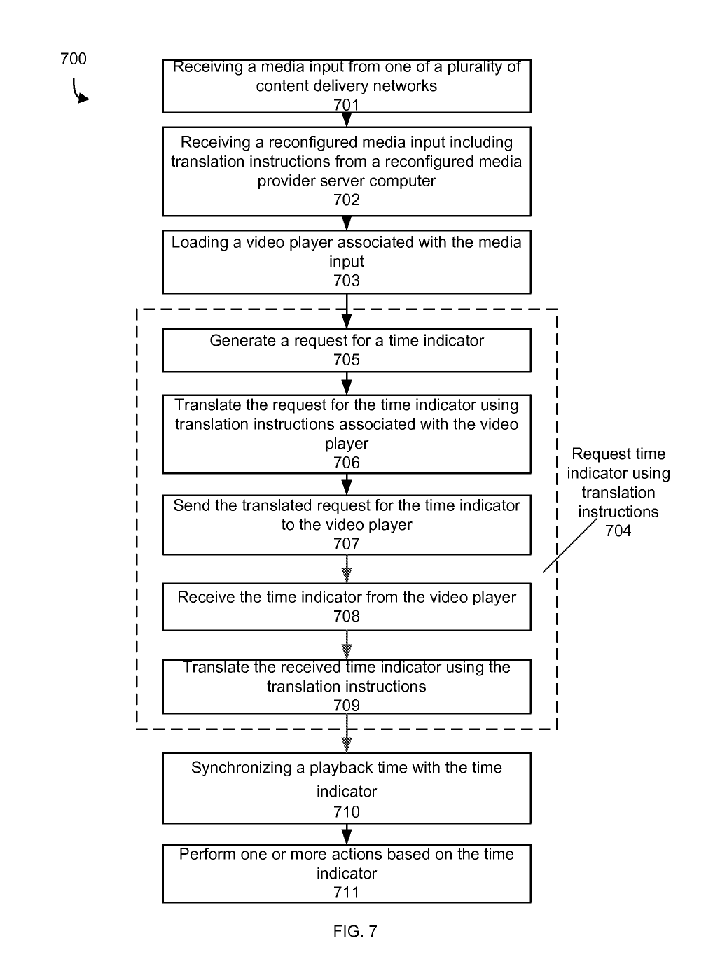

Accordingly, the browser 111 may load a video player 112 associated with the received media input. Further, the master platform 113 may use the translation instructions to format and interact with the video player 112 to provide the uniform appearance and functionality of the video player 112 associated with the media input. Further details regarding use of the translation instructions is provided below in reference to FIGS. 7-12.

At step 570, the user computer 110 may send requests for information to the reconfigured media server computer 141. The information may comprise any suitable non-media inputs that may be used to provide a reconfigured media presentation experience. For example, the user computer 110 may request chat messages, engagement data, and any other information that may be displayed to a user during playback of the media input.

At step 580, the reconfigured media provider 140 sends the requested non-media inputs to the user computer 110. The reconfigured media provider 140 may identify the user computer 110, user account, user input, or any other relevant information to identify non-media inputs associated with the information request. The master platform 113 may then use and/or display the received non-media inputs associated with the media input to the user through the browser 111.

At step 590, the user computer 110 may send information to third parties during the playback of the media input based on user inputs, a playback time, or any other interactions or actions at the user computer 110. For example, as shown in FIG. 10, the user computer 110 may generate expressions based on a user input (e.g., chat message, wall post, social media network share, etc.) and send the expressions to one or more designated social media server computers 132.

Accordingly, embodiments of the present invention allow a user to request a media input from any third party website 170, receive and play the media input, receive and play non-media inputs associated with the media input, and interact with multiple third party computers based on user inputs, playback conditions, or any other information obtained or determined at the user computer 110.

As described previously in reference to step 540 above, FIG. 6 shows a flow diagram of an example method 600 of delivering a reconfigured media input to a user computer 110 with translation instructions associated with a media input, according to one embodiment of the present invention.

At step 601, the reconfigured media server 141 receives a request from a user computer 110 for a reconfigured media input. As described previously in steps 530 and 540 above, the reconfigured media provider 140 may determine the user account associated with the request and may prompt the user to log-in or otherwise authenticate themselves.

At step 602, a translation instructions determination module 142 of the reconfigured media server 141 determines a media input associated with the reconfigured media input request. The reconfigured media server 141 may identify the media input through any suitable method. For example, the input request may include an identifier (e.g., name, product identifier, merchant associated link, etc.) associated with a media input.

After the reconfigured media provider 140 determines the media input being requested, an API translator module 142 at the reconfigured media server 141 may also determine the media content provider 160(a)-160(d) that is associated with the requested media input and/or is responsible for distributing the requested media input. The API translator 142 may determine the content delivery network 150(a) through any suitable manner including a look up table, information contained within a translation instructions database 143, etc.

At step 603, the reconfigured media provider 140 determines translation instructions associated with the media input, content delivery network 150(a), media provider 160, or video player 112. Once the media input is identified by the reconfigured media provider 140, the content delivery network 150(a), media provider 160, video player 112, and any other information may be determined by searching a database of product or media input information obtained during registration, configuration, or generation of the non-media inputs associated with the media input.

As described previously in reference to FIG. 4, the translation instructions may be stored according to content delivery network 150(a), media provider 160, or media input depending on whether each party may have a different translation for each media input, each media provider 160, or by content delivery network 150(a). Accordingly, any of the parties may be used to identify the correct translation instructions. For example, the translation instructions determination module 142 may identify the media input and the media input may include a translation instructions identifier associated with the video player 112.

Alternatively, the correct translation instructions may be determined by the content delivery network 150(a), media provider 160, or video player 112 associated with the media input. For example, some content delivery networks 150(a)-150(c) may use the same video player 112 with the same API commands for each media input that they deliver to user computers 110. Accordingly, the translation instructions may be determined by determining a content delivery network 150(a) associated with the media input and identifying the translation instructions associated with the content delivery network 150(a).

However, some content delivery networks 150(a)-150(c) may allow media providers 160(a)-160(d) to alter the provided API instructions to allow for different functions or options between media providers 160(a)-160(d) (e.g., movie distributors or movie producers) or between media inputs (may allow some movies to have more advanced user interaction functions than others). Accordingly, for such content delivery network 150(a)-150(c), the translation instructions may be determined by determining translation instructions associated with the media input or by determining the video player 112 associated with the media input, and identifying translation instructions associated with the video player 112. The configuration information for the content delivery network(a) may be stored along with the media input information at the reconfigured media provider 140 and may be determined by the translation instructions identifier module 122.

At step 604, the reconfigured media server 141 may send a response to the reconfigured media input request by sending the translation instructions to the user computer 110. The translation instructions may be sent as part of the reconfigured media input response including non-media inputs. Accordingly, before sending the translation instructions to the user computer 110, the reconfigured media server 141 may identify engagements and chat messages associated with the media input and sending the response to the user computer 110 including the engagements, chat messages, and the translation instructions. Alternatively, the translation instructions may be sent in a separate message as soon as the translation instructions are identified.

Note that the translation instructions may be provided in the reconfigured media input response message or an identifier for the translation instructions that identifies the translation instructions may be provided instead. Accordingly, in some embodiments, the translation instructions may be stored at a user computer 110 and the reconfigured media input response message may merely comprise an identifier for the translation instructions that the master platform 113 should use with the media input. Therefore, in some embodiments, the translation instructions may include a translation identifier for translation instructions stored on the user computer 110 and the translation instructions may not include the actual API or interface translations associated with the video player 112. Accordingly, the above method is merely illustrative and many other processes are available for providing the translation instructions for the user computer 110.

### IV. Using Translation Instructions

After a user computer 110 receives the reconfigured media input response message and receives the media input from the content delivery network 150, the user computer 110 may use translation instructions 122 associated with a video player 112 associated with the media input to provide the reconfigured media presentation viewing experience. The reconfigured media presentation viewing experience may include display of non-media inputs associated with the media input and may allow a user to interact with the media input to share their thoughts, buy merchandise related to the media input, ask questions, and otherwise engage with the media content. Accordingly, the user computer 110 may use a master platform 113 included in the received reconfigured media input or previously installed on the user computer 110 to view and interact with the reconfigured media presentation. However, the non-media inputs may be time-dependent such that the master platform 113 may need to identify a time indicator from a video player 112 in order to display relevant non-media inputs to the user. Accordingly, the translation instructions 122 may be used to synchronize a playback time with a variety of video players.

A. Synchronizing a Playback Time with a Variety of Video Players

The non-media inputs associated with the media content of the media input may be time-dependent such that the non-media inputs being displayed to a user are relevant to the user. Accordingly, the non-media inputs may comprise queue times to inform a master platform 113 of when to trigger the display of the chat messages, offers, quotes, polls, etc., to enhance the user's viewing experience.

Accordingly, the master platform 113 may determine the time of the video player 112 at any given moment during playback. However, because of the wide variety of video players that may be used to display the media input on the user computer 110, each with their own interfaces, commands, controls, and instructions for requesting or providing time indications of the playback time of a media input, the master platform 113 may use the translation instructions 122 to communicate with a video player 112 to determine the playback time of the video player 112. Accordingly, the master platform 113 may use the translation instructions 122 to synchronize a playback time using a time indicator of a video player 112.

Due to the wide variety of video players, the methods for determining a current time indicator associated with the video player 112 may change based on the configuration of the video player 112. Accordingly, some video players may respond to requests for time indicators while other video players may publish the time indicator. The master platform 113 may be configured to receive a time indicator from the video player 112 using either method.

1. Requesting Time Indicators from a Variety of Video Players

FIG. 7 shows a flow diagram of an example method 700 of using translation instructions 122 to synchronize a playback time of video player 112 with a master platform 113 where the video player 112 is configured to respond to time indicator requests. Accordingly, the method described in FIG. 7 may be used to request a time indicator from a video player 112 using translation instructions 122 associated with the video player 112.

At steps 701 and 702, the user computer 110 may receive the reconfigured media input and the media input that may be displayed on the user computer 110 using the video player 112. These steps are described in further detail above in relation to FIG. 5.

At step 703, the browser 111 operating on the user computer 110 recognizes a video player 112 that the media input is configured to be played on and loads the video player 112 for playback of the input media. The video player 112 may load the media input and prepare the media input for playback. In some embodiments, the video player 112 may start playing immediately upon loading and in other embodiments, the video player 112 may wait for a user to select a start button or other interaction to start the playback. Either way, the master platform 113 may perform a number of authentication and configuration processes to prepare the master platform 113 for playback. For example, the master platform 113 may load the non-media inputs (e.g., engagements) associated with the media input.

At step 704, the master platform 113 may request a time indicator using translation instructions 122 using the steps described below. Many of the steps below are optional and are dependent on the specific configuration of the video player 112 that is loaded. Accordingly, the steps described below may be performed in different orders, combinations, may be missing one or more steps, and are otherwise configurable depending upon the video player 112. Additionally, in some embodiments, depending on the configuration of the translation instructions 122, many of the individual steps may be combined into a single step. For example, if the master platform 113 is delivered to the user computer 110 with the translation instructions embedded in the master platform commands, the generating and translating steps (steps 704-705) may be performed in a single step.

In some embodiments, the master platform 113 may wait for an indication that a user has started playing the media input through the video player 112 before the master platform 113 starts requesting time indicators. In other embodiments, the master platform 113 may slow down a sampling time for requesting time indicators until it determines that the video has begun. In other embodiments, the master platform 113 may wait until it receives a user input to start playing the media input or a communication from the video player 112 that the user has requested playing of the media input.

For embodiments where the master platform 113 waits for a user input or communication indicating that the video player 112 has begun playing the media input, the master platform 113 may be active and wait for an API command that identifies the user has requested the video to start playback. The translation instructions 122 may be used to translate the received API command from the video player 112 to interpret and understand the information being provided by the video player 112. For example, the master platform 113 may receive a message from the video player 112 that includes a “playstart” indicator. Accordingly, the master platform 113 may use the translation instructions 122 to determine that for the video player 112, “playstart” means that the user has pressed a play button. Accordingly, the translation instructions 122 may translate the “playstart” to an indicator that the master platform 113 recognizes, (e.g., “playbutton”). At that point, the master platform 113 may start requesting a time indicator from the video player 112 using the steps 705-709 described below.

At step 705, the master platform 113 generates a request for a time indicator. The request for the time indicator may be generated using a generic command associated with the master platform 113. For example, the master platform 113 may generate a command including “request: time” or “what time is it?” Any other request may be generated including any format, content, code language, etc. However, the loaded video player 112 may not understand this command.

Accordingly, at step 706, the translation module 114 may translate the request for the time indicator using translation instructions 122 associated with the video player 112. For example, the translation module 114 may translate the command “request: time” to “give me the current time” or to a hexadecimal value, for example, “0H8C8167.” Accordingly, the translation instructions 122 may translate both content, format, data type, language, or any other information of the request.

At step 707, the master platform 113 sends the translated request for the time indicator to the video player 112. The video player 112 may recognize the translated request because the translation instructions 122 configured the request to match the API of the video player 112. Accordingly, the video player 112 may check the time and respond to the video player 112 with a time indicator of the current view being displayed. The time indicator may include any relevant information and format. For example, the time indicator may be “0” when the video is not playing or may include words (e.g., “none”, “sixty seconds”, etc.), or may include a value in seconds, minutes, hours, (e.g., “1:05”, or “65”), or any other information that may indicate the playback time.

At step 708, the master platform 113 receives the time indicator from the video player 112. If the video player 112 provides the time indicator in a unique or atypical manner, the master video may further translate the received time indicator. However, if the time indicator is provided in seconds, the master platform 113 may understand the time indicator without translating the time indicator.

At step 709, when the master platform 113 does not understand the time indicator or when the translation instructions 122 dictate that the time indicator may be translated, the master platform 113 translates the received time indicator form the video player 112. Accordingly, the content, format, or any other part of the time indicator may be translated to a format that is understandable by the master platform 113.

At step 710, the master platform 113 may synchronize a playback time with the time indicator. The master platform 113 may track, monitor, and/or manage an independent playback time that the master platform 113 uses to perform a number of actions. For example, the master platform 113 may trigger engagement at a queue time associated with the engagement. Accordingly, the master platform 113 may use a clock function to receive the time indicator from the video player 112 and may set the playback time to the received time indicator. Accordingly, between the next time indicator request, the master platform 113 may use the clock or timer function to increment and manage the playback time in order to perform the one or more actions based on the time indicator. Accordingly, the master platform 113 now knows the current playback time of the video player 112.

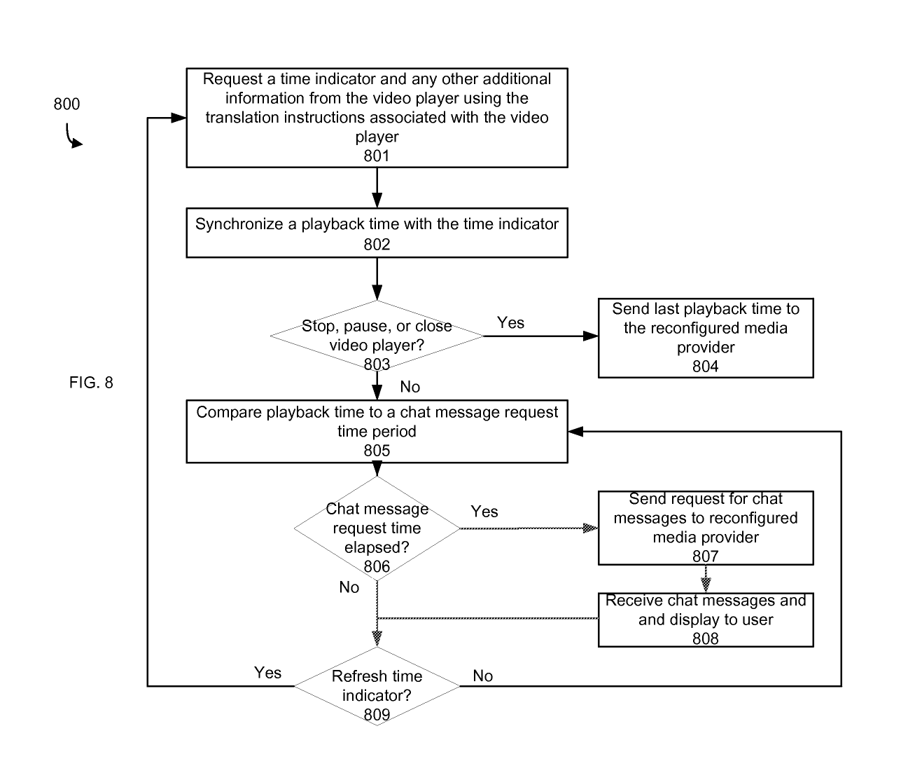

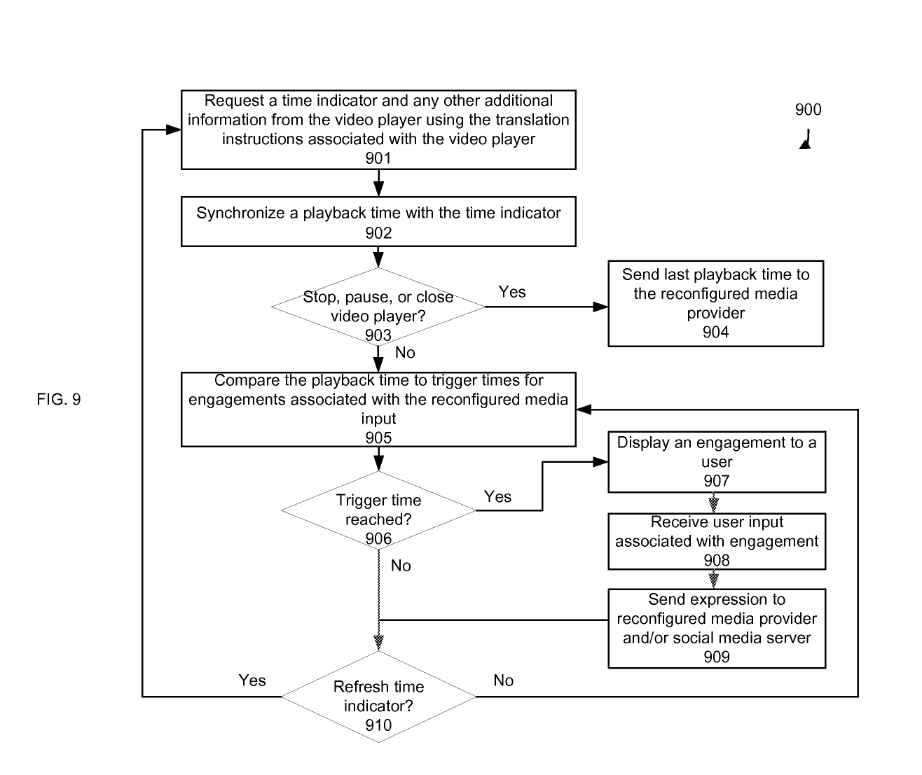

At step 711, the master platform 113 uses the playback time to perform one or more actions based on the received time indicator. The master platform 113 may perform any number of actions based on the synchronized playback time (which is based on the received time indicator). For example, the master platform 113 may send an expression message (e.g., a message may be sent to a social media network including “john is watching movie A” once 30 seconds has elapsed), request additional information from the reconfigured media server computer 141 (e.g., updated chat messages), or may trigger engagement data to be displayed at a queue time associated with the engagement. Further detail regarding the actions are provided below in reference to FIGS. 8 and 9 below.

Accordingly, a master platform 113 may use translation instructions 122 to receive a time indicator from a video player 112 and perform any number of actions based on the received time indicator. As described in more detail in FIGS. 8-9 below, steps 704-711 may be repeated periodically or according to a criteria to continue to keep the playback time current with the user's playback of the media input. Further, the process 700 above may be repeated for any number of different video players and may be used to receive time indicators from any number of different video players with different API commands.

2. Receiving Time Indicators from a Variety of Video Players

As explained above, some video players may be configured to publish a time indicator periodically but may not respond to requests for such times. Accordingly, the above process may be altered to allow the master platform 113 to listen for time indicator publishing information from the video player 112, translate the time indicator to a format that may be understood by the master platform 113, and synchronize a playback time using the time indicator. Accordingly, requests are not required to be sent and instead, the master platform 113 may receive published time indicators from the video player 112, translate the published time indicators, and synchronize the playback time using the received time indicators without requesting a time indicator.

B. Performing Actions Using the Synchronized Playback Time

As explained above in reference to step 711, the user computer 110 may perform a number of different actions based on the time indicator and/or synchronized playback time of the master platform 113. For example, the user computer 110 may request input data or send output data to any number of third parties based on the synchronized playback time of the master platform 113.

For example, the master platform 113 may request chat messages from the reconfigured media provider 140, may display engagements to the user, or may send expressions to social media server computers 132 based on the playback time of the video player 112. These examples are provided in more detail in reference to FIGS. 8-9 below, however, the provided examples are illustrative only and a number of other actions may be performed based on the synchronized playback time received by the master platform 113.

1. Requesting/Receiving Data Inputs Based on Playback Time

FIG. 8 shows a flow diagram of an example method 800 of using translation instructions 122 to synchronize a playback time and using the playback time to request chat messages associated with a media input, according to embodiments of the present invention.

Steps 801-802 a time indicator is requested or received by the master platform 113 and a playback time is synchronized to the time indicator. These steps are described in more detail above in reference to steps 704-710.

At step 803, the master platform 113 may use the received time indicator or synchronized playback time to determine if the video player 112 has been stopped, paused, or closed. These determinations may be made through any suitable method. For example, the master platform 113 may use readings of the received time indicator to determine whether the player is stopped, paused, closed. For instance, if the received time indicator is constant across multiple readings from the video player 112, the master platform 113 may determine that the video is paused or stopped. Alternatively, if the video player 112 no longer responds to the time request, the master platform 113 may determine that the video player 112 was closed. The master platform 113 may also request a status update from the video player 112 if the video player 112 supports such a request.

Any other suitable methods may be used to determine if the user has stopped the player. For example, the master platform 113 may receive a translated published status from the video player 112. The published status of the video player 112 may be provided when the user interacts with the video player 112 (e.g., a user input to stop, pause, or close the video player 112). Accordingly, the master platform 113 may translate the received indicator using a process similar to that disclosed above in regards to the time indicator request and may determine the video players status through that method.

At step 804, if the master platform 113 determines that the video is paused, stopped, or closed, the master platform 113 may pull the current playtime (or the last playtime received) from the video player 112 and send the playback time to the reconfigured media server 141 to be stored and associated with the user account. Accordingly, if the user returns to the page or resumes play of the media input, the video player 112 may be returned to that spot for the continuation of the users video experience. The latest play time may be included in the reconfigured media input delivered to the user computer 110 and may be delivered to the video player 112 using translation instructions 122.

At step 805, if the video player 112 is not paused, stopped, or closed, the master platform 113 may compare the playback time to a chat message request time period. In some embodiments, in order to deliver updated chat messages from other users interacting with a reconfigured media input, the master platform 113 may request periodic updates of chat messages from the reconfigured media provider 140 based on the playback time of the video player 112. Accordingly, the master platform 113 may check whether it is time to send a chat message request to the reconfigured media input by comparing the synchronized playback time to a chat message request time period.

At step 806, the master platform 113 may determine whether the chat time request period has elapsed and whether it is time to request updated chat messages from the reconfigured media server 141. The master platform 113 may track or monitor the period since the last chat message request was sent to the reconfigured media provider 140 using any suitable method. For example, a chat message request timer may be implemented that keeps track of the time that has elapsed since the last chat message request was sent. The chat message request timer allows the reconfigured media provider 140 to keep the chat messages that are delivered to the user computer 110 relevant to the current video playback time of the video player 112. Accordingly, if the user has skipped forward from 30 seconds into the video playback to 30 minutes into the video playback, if the master platform 113 does not update chat messages, the delivered chat messages may not be relevant to the content being viewed. Accordingly, the chat request message timer may be used to periodically request new chat messages from the reconfigured media provider 140.

For example, if the chat request time period is 10 seconds and a time indicator request is sent every 2 seconds, a time indicator may be received 5 times before a new chat request is sent. Accordingly, if the user has not skipped ahead in the video, the received time indicators may match with the chat message request timer. However, if the playback time jumps to 1 minute from 30 seconds, the playback time may now show that 30 seconds has elapsed and that the 10 second timer has elapsed. Accordingly, the master platform 113 may determine that a the chat message request time has elapsed.

At step 807, the master platform 113 determined that the chat message time period elapsed so the mater player sends a request for chat messages to the reconfigured media provider 140. Accordingly, the master platform 113 may send a request for updated chat messages based on the received time indicator from the video player 112. The chat message request message may include the received time indicator to ensure that the chat messages that are received are relevant to the current playback of the video.

At step 808, the reconfigured media provider 140 determines chat messages that are most relevant to the user and responds with chat messages. The master platform 113 may display the chat messages to the user based on the playback time. Further description of chat message display, chat message request messages, and chat message response messages may be found at U.S. patent application Ser. No. 13/961,783, filed Aug. 7, 2013, by Regan Poston, et al., which is incorporated by reference in its entirety for all purposes.

At step 809, the master platform 113 determines whether the master platform 113 should request another time indicator from the video player 112. The master platform 113 may determine whether it is time to refresh the time indicator through a number of methods including requesting the time indicator periodically or using one or more criteria.

The master platform 113 may refresh the time indicator by sending a request to the video player 112 periodically according to a sampling period. The sampling period may change depending on the type of user computer 110 requesting the time indicator. For example, mobile devices that are limited in battery power may have a larger sampling period (e.g., sample every 5 seconds) than a desktop or laptop computer (e.g., sample every 2 seconds) with more battery resources. Accordingly, embodiments may communicate with a system to determine the type of device being used or may determine the type of device based on the browser 111 being operated by the user computer 110 and change the sampling period accordingly.

Further, in some embodiments, the sampling period of the time requests may be impacted by the status of the video player 112. Accordingly, if the video player 112 is paused, the sampling period may be larger than if the video player 112 is playing (e.g., every 10 seconds when paused vs. every 2 seconds when playing).

Alternatively, the master platform 113 may determine whether it is time to refresh the time indicator based on one or more criteria. The criteria may include any information that may be relevant to the playback of the video player 112. For example, the criteria may be based on a type of user input or may be based on information received from the video player 112.

A type of user input may include a user input to stop, play, pause, close, skip, or otherwise change the playback of the media input on the video player 112. For example, if the master platform 113 either receives a published status from the video player 112 (e.g., stopped, paused, skip, etc.) or receives the user input directly, the master platform 113 may trip a flag or otherwise indicate that a criteria for refreshing the time indicator has been met. For example, if a user skips from 30 seconds to one minute by using a scroll bar on the bottom of the video player 112, the video player 112 may publish or send a notice to the master platform 113. The master platform 113 may translate the received notice and may determine that the criteria for updating the refresh time indicator has been met. Accordingly, the master platform 113 may request a time indicator from the video player 112.

2. Outputting Data Based on Playback Time

The master platform 113 may also be configured to output data based on the synchronized playback time based on the received time indicator. Some examples are provided below, however, the examples below are meant to be illustrative only and any number of other data output actions may be completed based on the playback time.

a) Displaying Engagement Data to the User

FIG. 9 shows a flow diagram of an example method 900 of using translation instructions 122 to synchronize a playback time and use the playback time to display engagement information to a user computer 110 and output data to third parties, according to one embodiment of the present invention. Engagements (e.g., poll questions, trivia questions, advertisements, etc.) associated with the media input may be received from the reconfigured media provider 140 and the engagement data may comprise trigger times or queue points that allow the master platform 113 to trigger the engagement data at the appropriate time during video playback. Accordingly, a master platform 113 may complete an action including providing output data based on the received time indicator by triggering an engagement to be displayed to the user.

At steps 901-904, the master platform 113 may perform the same steps as described above in reference to FIG. 8 to obtain a time indicator, synchronize a playback time, determine if the player is stopped and whether the last playback time should be reported for future use to the reconfigured media provider 140 or stored on the user computer 110.

At step 905, the master platform 113 may compare the synchronized playback time to a trigger time (i.e., queue time) for one or more engagements. Accordingly, the master platform 113 may receive engagement data from the reconfigured media server 141 and may determine trigger times for the media input based on the playback time of the video player 112. Accordingly, when the master platform 113 synchronizes the playback time, the master platform 113 compares the synchronized playback time to the trigger times for the engagements.

At step 906, the master platform 113 may determine whether the trigger time has been reached for an engagement by determining if the playback time has reached a trigger time for an engagement. For example, a media input may have 3 different engagements with trigger times at 28, 126, and 254 seconds into the playback of the media input. The master platform 113 may determine whether the trigger time has been reached by comparing a current playback time (e.g., 25 seconds) to the trigger times of the loaded engagements (e.g., 28, 126, and 254 seconds). Accordingly, none of the trigger times match the current playback time. Accordingly, no engagement may be triggered and the process may continue. Whether a time request has been triggered or not at step 910, the process may return to compare the playback time to the trigger time soon thereafter. The process may be repeated at a fast enough period that no engagement trigger times may be missed. Accordingly, a number of comparisons may occur without any engagements being displayed but eventually, a trigger time may match the playback time. Accordingly, once the playback time equals 28 seconds, the first engagement (e.g., a poll question related to the scene at 28 seconds) may be displayed. Accordingly, the trigger time has been reached and the process moves to step 907.

At step 907, the master platform 113 may display the engagement to the user when the playback time matches the trigger time for the engagement. For example, using the example above, the master platform 113 may display the poll question (e.g., “what is your favorite movie starring the actor John Doe?”) on the browser 111 with a number of potential answers (e.g., “(a) movie a, (b) movie b, (c) movie c, (d) movie d”). Accordingly, the engagement data is displayed on the browser 111 and the user may interact with the answers to provide data input.

At step 908, the master platform 113 may receive a user input associated with the engagement. For example, using the example above, the user may select option (a) (e.g., “Movie A”) and the master platform 113 may receive the user's answer to the poll question.

At step 909, the master platform 113 may send an expression associated with the engagement to the reconfigured media computer and/or a social media server computer 132. The reconfigured media provider 140 may be interested in finding out more information about the user and may store answers to engagements as user interactions in a database at the reconfigured media provider 140. Alternatively, the master platform 113 may generate an expression to let friends of the user know that the user answered a poll and provide the answer provided by the user (e.g., the expression may state “User just answered a poll question and believes that Movie A is the best film starring John Doe. What is your favorite movie John Doe stars in?”). Accordingly, the master platform 113 may generate an expression and/or an interaction based on the user input and send the expression to a reconfigured media provider 140 or social media website 130. Accordingly, the master platform 113 may perform one or more actions including generating and send output data based on time indicators received from the video player 112.

At step 910, the master platform 113 may determine whether it is time to refresh the time indicator by requesting a new time indicator from the video player 112 using the translation instructions 122. This step is described in more detail in reference to FIG. 8 above.

b) Displaying Other Information Based on Playback Time

The above example provided in FIG. 9 is merely one example of output data that may be displayed and generated based on time indicators received from the video player 112. Accordingly, similar processes to those described above may be used to complete other actions.

For example, another example includes that the master platform 113 may display the received time indicator to the user, may prompt the user for input related to whether they are still watching the video (e.g., in the case of an extended period of inactivity), or any other suitable actions may be provided.

c) Sending Expression Based on Playback Time

As explained above in reference to FIG. 9, the master platform 113 may also send information (e.g., an expression message) to a third party computer based on a video playback threshold. For example, an expression message saying “John Doe is watching Movie P! Follow the link below to join him!” may be sent if the playback time reaches 30 seconds. Accordingly, friends of the user may be able to see the notice through their profile on the social media network website and may watch the movie as well and could chat with the user as they watch. The expression may have a trigger time much like the engagements described in reference to FIG. 9 above but instead of displaying the engagement data, an expression may be sent to one or more third parties (e.g., a merchant, social media server 132, etc.).

C. Receiving Additional Information from a Variety of Video Players

Additionally, in some embodiments, the master platform 113 may receive additional information from a variety of video players using the translation instructions 122. The master platform 113 may perform similar processes as described above using the additional information to perform a number of actions based on the additional information received from the video player 112. For example, the master platform 113 may receive user inputs associated with video player controls (e.g., play, stop, pause, etc.) as well as receive metadata (e.g., information embedded into the media input outside of the actual video) associated with the media input. For the sake of brevity, the processes for performing actions will not be described, but one of ordinary skill would recognize how the above described processes could be altered to perform the actions described above based on the received additional information.

1. Video Player Controls

As explained previously, the master platform 113 may also be configured to receive published user interactions associated with video controls. For example, the same methods described above may be used to trigger engagements, synchronize a playback time, send expressions to third parties, or any other suitable actions may be completed based on video player control information (e.g., status of a video player 112, user inputs related to video player controls, etc.). For example, if a user stops a video player 112, the video player 112 may send a stop notice to a master platform 113 and the master platform 113 may store the last received playback time associated with the user.

2. Metadata

When metadata is included with the media input, the master platform 113 can request or receive the metadata from the video player 112 using the translation instructions 122 and the master platform 113 may generate custom engagements automatically. For example, a “like” engagement can be linked to the actors social media page. Furthermore, polls and trivia can be created based off of either the inclusion or exclusion of data pulled from other services like IMDB™. For example, the master platform 113 may request a list of movies from IMDB™ for actor John Doe and a few other random movies he didn't star in and the reconfigured media provider 140 could generate a question like “What movie did John Doe star in?” or “What movie DIDN'T John Doe star in?” Furthermore, the master platform 113 can also craft engagements around the director, the year of release (“Movie A hit theatres in the summer of 1975.”), genre (“What is your favorite horror film?”) and any other meta data provided.

Accordingly, the metadata could be used to generate dynamic engagements based on keyword searching, obtaining data from third party websites, and algorithms directed at generating particular engagements from the known metadata tags.

D. Translating Video Player User Interfaces

FIG. 10 shows an example of a format of a display 1000 of a translated video player 1012A on a browser 111 operating on a user computer 110, according to one embodiment of the present invention. Accordingly, FIG. 10 shows some of the increased functionality provided by embodiments of the present invention. FIG. 10 shows an exemplary user interface for a user that has requested a media input from a reconfigured media provider 140. As can be seen in FIG. 10, the media input may be shown in the display of the user's browser 111, application, or other user interface and other non-media inputs 1011, 1013-1015 may be shown on the graphical display or interface as well. For example, FIG. 10 shows sponsorship information 1011 as well as event or media title 1011, sponsored Q&A 1013, sponsored polls, product promotions, and/or trivia 1014, as well as a dynamic segmented chat area 1015 of the graphical interface of the master platform 1010. The media input that is delivered by a content delivery network 150 is embedded into one area of the screen and the rest of the screen is related to non-media inputs associated with the media input that may allow a consumer to further interact with the media input 1002.

Based on a time code, cue points, or other time related information embedded into the media input or provided by the translation instructions 122, the non-media inputs 1011, 1013-1015 may be displayed, triggered, changed, or interacted with based on the media input. Additionally, more non-media inputs that are not shown may be provided by the translation instructions 122 or the reconfigured media provider 140 as one or ordinary skill in the art would recognize. A different layout, more functionality, or different functionality may all be provided by the reconfigured media input and the displayed layout and functionality should not be viewed as limiting the available display functions of the media player.

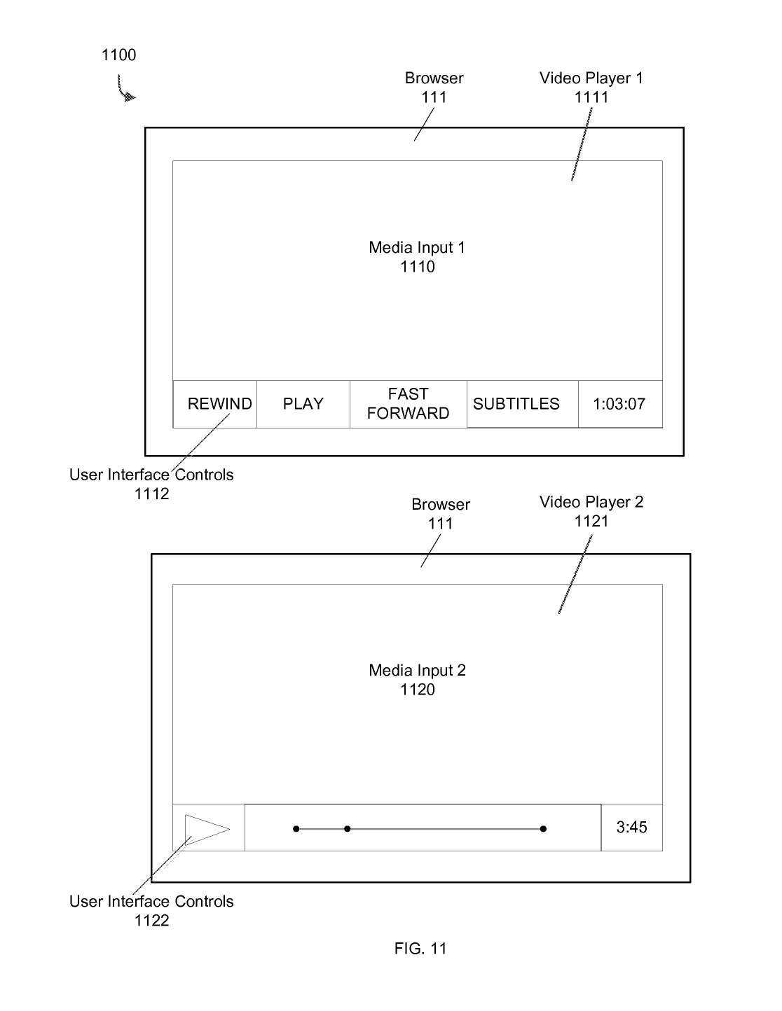

FIGS. 11A-11B show examples of two traditional video players 1111, 1121 on a browser 111 operating on a user computer 110, according to one embodiment of the present invention. As can be seen in FIGS. 11A and 11B, the two video players 1111, 1121 look different and have different user interfaces (e.g., different control button displays and functionality). However, the reconfigured media provider 140 may desire to show a uniform video experience for all users across media inputs associated with any content delivery networks 150(a)-150(c) or media providers 160(a)-160(d). Accordingly, a master platform 1010 may embed video playback user interface controls 1012B on top of the video players 1111, 1121 to make the functionality and controls look the same and allow a uniform user interface 1010, as shown in FIG. 10. The embedded video playback interface controls 1012B may result in a translated video player 1012A display that is uniform for any media inputs displayed by the master platform 1010.

Accordingly, the master platform 1010 may receive user inputs associated with the video player 1111, 1121 directly from the user by embedding user interface commands 1012B on top of the command buttons 1112, 1122 of the respective video players 1111, 1121. Accordingly, the master platform 1010 may translate the user input (e.g., video play input) to a command that the video player 1111, 1121 may recognize and may send the translated command to the video player 1111, 1121 to complete the user input command.

For example, the master platform 1010 may receive a user input (e.g., play button interaction) associated with a translated video player 1012A user interface command 1012B from a user. For instance, the user interface commands 1012B may include play, pause, fast forward, rewind, stop, or jump to a playback position. The master platform 1010 may overlap or embed buttons associated with the user inputs on top of the display of the control buttons 1112, 1122 of the video player 1111, 1121. Accordingly, the video player 1111, 1121 may be controlled using commands received by the master platform 1010 instead of the video player 1111, 1121. The master platform 1010 may translate the user interface command using the translation instructions 1210, 1220 associated with the video player 1111, 1121, and may send the translated user interface command to the video player 1111, 1121 so that the video player 1111, 1121 performs the requested command (e.g., pause, play, fast forward, etc.).

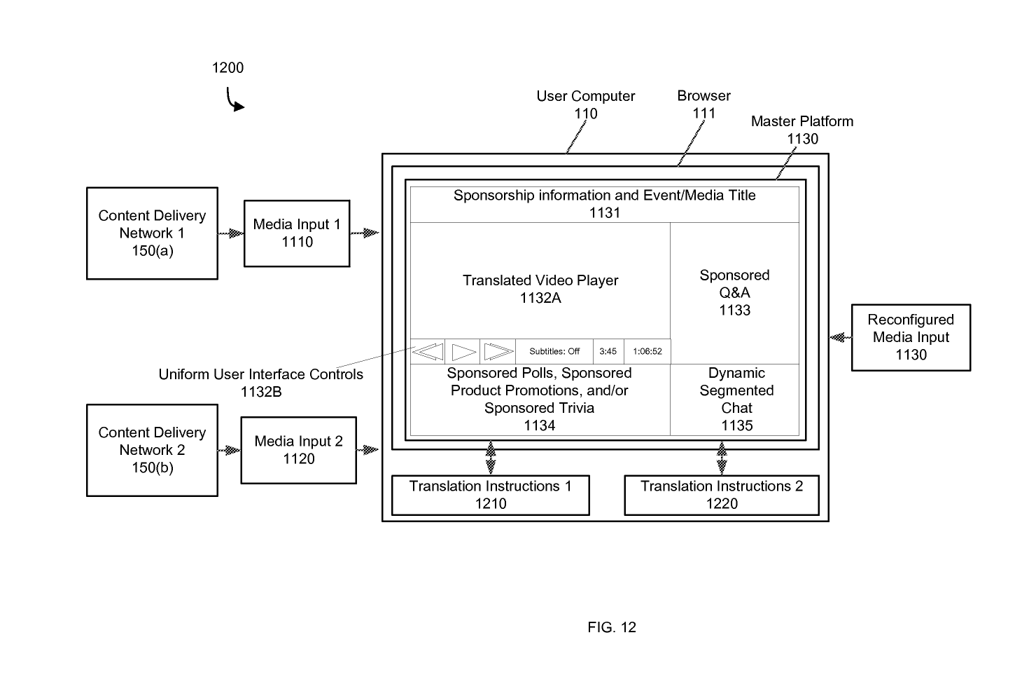

FIG. 12 shows an example of a screenshot of a display of a translated video player on a browser 111 operating on a user computer 110 for both of the media inputs shown in FIGS. 11A-11B, according to one embodiment of the present invention. As can be seen in FIG. 12, the user computer 110 may receive two different media inputs associated with two different content delivery network 150(a)-150(b). The two different content delivery networks 150(a)-150(b) may configure the two different media inputs 1110, 1120 to be displayed by two different video players 1111, 1121 with different API commands, instructions, and user interface functionality 1112, 1122. Accordingly, the two video players 1111, 1121 may have two different translation instructions 1210, 1220 associated with the two video players 1110, 1120 that may be used by the master platform 1130 to provide a translated video player 1132A with uniform user interface and functionality 1132B. The reconfigured media input 1130 may provide the two different translation instructions 1210, 1220 at different times and the translation instructions 1210, 1220 may be stored on the user computer 110 for use by the master platform 1130 with the two different video players 1111, 1121. The two media inputs 1110, 1120 may be received and displayed at different times but the user interface and display of the translated video player 1132 may be the same for the playback of both media inputs 1110, 1120.

Accordingly, the master platform 1130 may use each respective video player 1111, 1121 to display the respective video content of the media inputs 1110, 1120 in the area of the translated video player 1132A of the master platform 1130, but the master platform 1130 may embed the uniform user interface controls 1132B of the translated video player 1132A on top of the display of the original video player user interface controls 1112, 1122. Accordingly, the master platform 1130 may receive video player control commands directly from the user through the uniform user interface controls 1132B, translate the commands, and provide the commands to the video player in order to control the video playback of the respective media inputs.

Although the following system may be described in terms of the reconfigured media server 141 performing the functionality of embodiments of the present invention, one of ordinary skill in the art would recognize that the actions may be performed by multiple entities within the system. Accordingly, embodiments should not be limited to a particular actor performing the actions described and instead the actions could be provided by any of the entities including the social media server 132, another server at the social media website 130, another server at the reconfigured media provider 140, the browser 111 running on the user computer 110, a third party that implements some of the functionality disclosed, or any other suitable entity in the system.

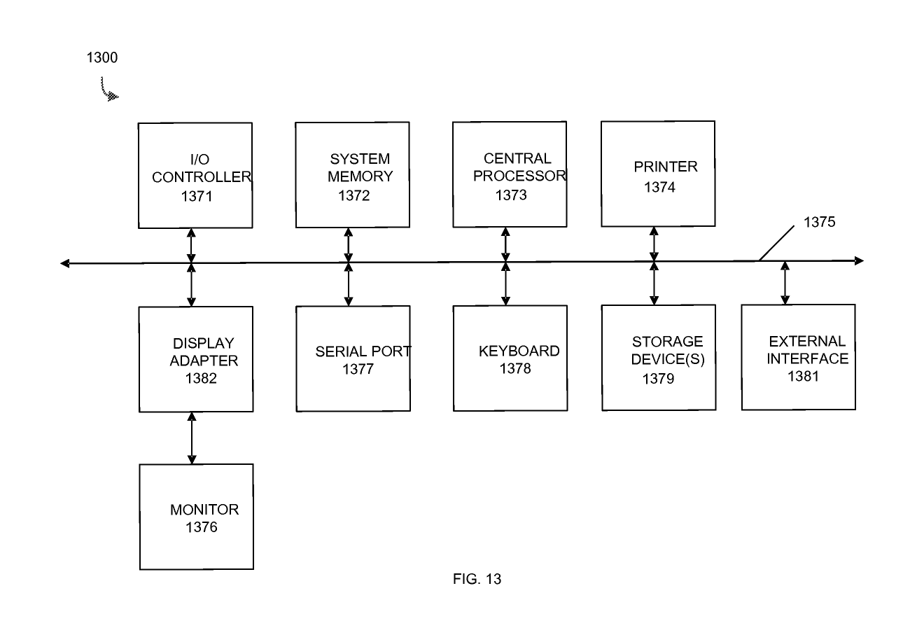

FIG. 13 shows a block diagram of an example computer system 1300 usable with system and methods according to embodiments of the present invention.

Any of the computer systems mentioned herein may utilize any suitable number of subsystems. Examples of such subsystems are shown in FIG. 13 in computer apparatus 1300. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 13 are interconnected via a system bus 1375. Additional subsystems such as a printer 1374, keyboard 1378, storage device(s) 1379, monitor 1376, which is coupled to display adapter 1382, and others are shown. Peripherals and input/output (I/O) devices, which couple to I/O controller 1371, can be connected to the computer system by any number of means known in the art, such as serial port 1377. For example, serial port 1377 or external interface 1381 (e.g., Ethernet, Wi-Fi, etc.) can be used to connect computer system 1300 to a wide area network such as the Internet, a mouse input device, or a scanner. The interconnection via system bus 1375 allows the central processor 1373 to communicate with each subsystem and to control the execution of instructions from system memory 1372 or the storage device(s) 1379 (e.g., a fixed disk, such as a hard drive or optical disk), as well as the exchange of information between subsystems. The system memory 1372 and/or the storage device(s) 1379 may embody a computer readable medium. Any of the data mentioned herein can be output from one component to another component and can be output to the user.

A computer system can include a plurality of the same components or subsystems, e.g., connected together by external interface 1381 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As user herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A method of interfacing with a plurality of video players, the method comprising:
receiving, at a user computer, a first media input from a first content delivery network of a plurality of content delivery networks, wherein the media input is associated with a first video player of the plurality of video players;
receiving, at the user computer, a reconfigured media input from a reconfigured media provider computer;
loading the first video player on the user computer;
generating, by a master platform, a request for a time indicator;
translating the request for the time indicator using first translation instructions associated with the first video player, wherein the first translation instructions are different than second translation instructions associated with a second video player;
sending the translated request for the time indicator to the first video player;
receiving the time indicator; and
performing one or more actions based on the received time indicator.

2. The method of claim 1, wherein the first and second translation instructions are received from the reconfigured media provider computer.

3. The method of claim 1, wherein the first and second translation instructions are stored on the user computer.

4. The method of claim 1, wherein the first translation instructions are associated with the first content delivery network and wherein the second translation instructions are associated with a second content delivery network.

5. The method of claim 1, further comprising translating the received time indicator using the first translation instructions.

6. The method of claim 1, wherein the reconfigured media input includes translation instructions associated with the first video player.

7. The method of claim 1, wherein the translation instructions include mapping information for translating API commands associated with a master platform to match the API commands of the first video player.

8. The method of claim 1, wherein performing one or more actions based on the received time indicator includes sending information to a third party computer.

9. The method of claim 8, wherein the information sent to the third party computer includes an expression message and wherein the expression message is sent after the received time indicator has reached a video playback threshold.

10. The method of claim 1, wherein performing one or more actions based on the received time indicator includes requesting chat messages from the reconfigured media provider computer.

11. The method of claim 10, wherein before requesting chat messages the method further comprises:
synchronizing a playback time with the time indicator;
comparing the playback time to a chat message request time period; and
sending request for chat messages when the chat message request time period has elapsed.

12. The method of claim 1, wherein the reconfigured media input includes engagements associated with the media input and wherein performing one or more actions based on the received time indicator includes triggering an engagement to be displayed to the user.

13. The method of claim 12, wherein before triggering the engagement to be displayed to the user, the method further comprises:
synchronizing a playback time with the time indicator;
comparing the playback time to a trigger time for the engagement; and
displaying the engagement to the user when the playback time matches the trigger time for the engagement.

14. The method of claim 12, further comprising:
receiving a user input associated with the engagement; and
sending an expression associated with the engagement to the reconfigured media computer.

15. The method of claim 1, wherein performing one or more actions based on the received time indicator includes displaying the received time indicator.

16. The method of claim 1, wherein the request for the time indicator is sent periodically according to a sampling period.

17. The method of claim 1, wherein the sampling period depends on a type of user computer.

18. The method of claim 17, wherein if the user computer is a mobile device, the sampling period is larger than if the user computer is a desktop computer.

19. The method of claim 1, wherein the request for the time indicator is sent based on a criteria.

20. The method of claim 19, wherein the criteria includes a type of user input or information received from the first video player.

21. The method of claim 1, wherein the request for the time indicator is a first request for the time indicator and wherein before sending the first request for the time indicator, the method further comprises:
receiving a user input to start playing the media input; and
sending an interaction message to the reconfigured media provider.

22. The method of claim 1, further comprising:
generating a request for additional information from the first video player;
translating the request for additional information using the translation instructions;
sending the request for additional information to the first video player;
receiving additional information from the first video player, wherein the additional information is included in metadata of the first media input;
translating the received additional information using the translation instructions; and
using the translated additional information to perform the one or more actions based on the received time indicator.

23. The method of claim 1, further comprising:
receiving a user input associated with a user interface command;
translating the user interface command using the translation instructions; and
sending the translated user interface command to the first video player, wherein the first video player performs the user interface command.

24. The method of claim 23, wherein the user interface command includes play, pause, fast forward, rewind, stop, or jump to a playback position.

25. The method of claim 1, further comprising:
receiving a second media input from a second content delivery network, wherein the second media input is associated with the second video player;
receiving a second reconfigured media input from the reconfigured media provider computer;
loading the second video player on the user computer;
generating, by the master platform, a request for a second time indicator;
translating the request for the second time indicator using second translation instructions associated with the second video player;
sending the translated request for the second time indicator to the second video player;
receiving the second time indicator; and
performing one or more second actions based on the received second time indicator, wherein the one or more second actions are the same as the one or more first actions.

26. A computer product comprising a computer readable medium storing a plurality of instructions for controlling a processor to perform an operation of the method of claim 1.

27. A method of generating translation instructions for a first video player and a second video player, the method comprising:
receiving a first media input and a first set of API commands associated with the first video player;
determining a first mapping of the first set of API commands to a global set of master platform functions;
generating, by a processor, first translation instructions for a master platform corresponding to the first mapping;
receiving a second media input comprising a second set of API commands associated with the second video player;
determining a second mapping of API commands to the global set of master platform functions; and
generating, by the processor, second translation instructions for the master platform corresponding to the second mapping,
wherein the first translation instructions and the second translation instructions are configured to allow the master platform to interface with both the first video player and the second video player.

28. The method of claim 27, wherein the global set of master platform functions include requesting a time indicator from a loaded video player.

29. The method of claim 27, wherein the global set of master platform functions include communicating user inputs to a loaded video player.

30. The method of claim 27, wherein the global set of master platform functions include requesting metadata from a loaded video player.

31. The method of claim 27, wherein the first media input is received from a first content delivery network and the second media input is received from a second content delivery network, and wherein the first and second content delivery networks are different.

32. The method of claim 27, wherein the first media input and the second media input are received from a first content delivery network.

33. A method of providing translation instructions to a user computer, the method comprising:
receiving a request for a reconfigured media input from the user computer;
determining, by a server computer, a media input associated with the reconfigured media input;
determining the translation instructions associated with the media input; and
sending a response to the user computer including the translation instructions, wherein the user computer displays the media input using a master platform that interacts with a video player associated with the media input using the translation instructions.

34. The method of claim 33, wherein the translation instructions include a translation identifier for translation instructions stored on the user computer.

35. The method of claim 33, wherein determining the translation instructions associated with the media input further comprises:
determining a content delivery network associated with the media input; and
identifying translation instructions associated with the content delivery network.

36. The method of claim 33, wherein determining the translation instructions associated with the media input further comprises:
determining the video player associated with the media input; and
identifying translation instructions associated with the video player.

37. The method of claim 33, wherein delivering a response to the user computer further comprises:
determining engagements and chat messages associated with the media input;
sending the response to the user computer including the engagements, chat messages, and the translation instructions.
